(19) United States
(12) Patent Application Publication
(10) Pub. No.: US 2009/0319273 A1
(43) Pub. Date: Dec. 24, 2009

(54) AUDIO CONTENT GENERATION SYSTEM, INFORMATION EXCHANGING SYSTEM, PROGRAM, AUDIO CONTENT GENERATING METHOD, AND INFORMATION EXCHANGING METHOD

(75) Inventors: Yasuyuki Mitsui, Tokyo (JP); Shinichi Doi, Tokyo (JP); Reishi Kondo, Tokyo (JP); Masanori Kato, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/307,067

(22) PCT Filed: Jun. 27, 2007
(86) PCT No.: PCT/JP2007/000701

§ 371 Date: Dec. 30, 2008

(30) Foreign Application Priority Data
Jun. 30, 2006 (JP) 2006-181319

(51) Int. Cl. G10L 13/08

(52) U.S. Cl. 704/260; 704/E13.002

(57) ABSTRACT

An audio content generation system is a system for generating audio contents including a voice synthesis unit 102 which generates synthesized voice from text; and is provided with an audio content generation unit 103 which is connected to a multimedia database 101 in which contents mainly composed of audio article data V1 to V3 or text article data T1 and T2 are registered respectively, generates synthesized voice SYT1 and SYT2 for the text article data T1 and T2 registered in the multimedia database 101 by using the voice synthesis unit 102, and generates audio contents in which the synthesized voice SYT1 and SYT2 and the audio article data V1 to V3 are organized in accordance with a predetermined order.

### TECHNICAL FIELD

The present invention relates to an audio content generation system, a program, and an audio content generating method; and an information exchanging system and an information exchanging method, those of which use audio contents generated by them.

### BACKGROUND ART

With the achievement of broadband in the Internet and the widespread use of portable audio players, there have been increased services which deliver programs by audio of newspaper offices, TV stations, and the like. For example, there are provided services in which audio is used in blogs (weblogs, blog) that a plurality of users can freely transmit contents and comments (hereinafter, referred to as “audio blog”), and a service in which audio contents are automatically downloaded in a portable audio player (Podcasting). Further, nowadays, audio blogs made by not only businesses and institutions but also individual users have rapidly increased by services of content creation assistance sites by content providers and the like.

In this case, the contents indicate impression and criticism to different media of books, movies, and the like; citation from programs, diaries, and some sort of writings; and all sorts of writing text and audio such as music, skits, and the like. In the above mentioned audio blog service, with respect to contents created by a user, a different user browsed the contents can comment on that.

In this case, the comment means impression, criticism, agreement, counterargument, and the like with respect to the contents. With respect to the given comments, other user who browsed the above mentioned contents and the comments can further give comments, or a content creator further adds contents to the comments; and accordingly, contents including comments are to be updated.

Usually, with respect to contents transmitted by audio, return mail and impression are transmitted in text by a user who browsed by an input form or the like on mails and webs, and voiced in a website. A text-to-speech conversion device which is for obtaining synthesized voice from text data is disclosed in a patent document 1.

Furthermore, there is also known a service in which, with respect to audio contents, all contents and comments can be listened as audio by recording comments, storing as an audio file, and uploading.

Patent document 1: Japanese Patent Application Laid-Open No. 2001-350490

Non-patent document 1: Written by FURUI Sadaoki, “Digital Audio Processing,” Tokai University Press, 1985, pp 134 to 148

### DISCLOSURE OF THE INVENTION

However, in the above mentioned general audio blog service technology, there is a problem in that contents and comments written in text data can be delivered in audio, but it is not possible to treat comments sent in audio data.

Furthermore, in order to transmit comments in audio, there is another problem in that recording function has to be provided at a terminal of a personal computer (PC) or the like. For example, it is conceivable to disrupt exchange of comments between a user who uses a mobile phone having a recording function and a user who uses a PC having no recording function.

The present invention has been made in view of the above mentioned circumstances, and an object thereof is to provide an audio content generation system which generates audio contents capable of encompassing the contents of an information source including mixed text data or audio data, and can facilitate information exchange between users who access to the information source; a program which is for actualizing the audio content generation system; an audio content generating method using the audio content generation system; and its application system (information exchanging system) or the like.

According to a first aspect of the present invention, there are provided an audio content generation system, its program, and an audio content generating method. The audio content generation system includes a voice synthesis unit which generates synthesized voice from text; and further includes an audio content generation unit generates synthesized voice for the text data by using the voice synthesis unit from an information source including mixed audio data and text data serves as an input, and generates audio contents in which the synthesized voice and the audio data are organized in accordance with a predetermined order.

According to a second aspect of the present invention, there is provided an audio content generation system including a voice synthesis unit which generates synthesized voice from text, the audio content generation system including an audio content generation unit which is connected to a multimedia database in which contents mainly composed of audio data or text data are registered respectively, generates synthesized voice for the text data registered in the multimedia database by using the voice synthesis unit, and generates audio contents in which the synthesized voice and the audio data are organized in accordance with a predetermined order.

According to a third aspect of the present invention, there is provided an information exchanging system which includes an audio content generation system according to a second aspect of the present invention, and is used for information exchange between a plurality of user terminals, the information exchanging system including: a unit which accepts registration of text data or audio data from one user terminal to the multimedia database; and a unit which transmits the audio contents generated by the audio content generation unit to user terminals which require service by audio, wherein information exchange between the respective user terminals is actualized by repeating reproduction of the transmitted audio contents and additional registration of contents by the audio data or a text format.

According to a fourth aspect of the present invention, there is provided a program which is executed by a computer, which is connected to a multimedia database in which contents mainly composed of audio data or text data are registered respectively. The program makes the computer function as the following units of: a voice synthesis unit which generates synthesized voice corresponding to the text data registered in the multimedia database; and an audio content generation unit which generates audio contents in which the synthesized voice and the audio data are organized in accordance with a predetermined order.

According to a fifth aspect of the present invention, there is provided an audio content generating method which uses an audio content generation system connected to a multimedia database which has contents mainly composed of audio data or text data respectively registered therein, and has content attribute information including at least one of created date and time, circumstances, the number of past data creations, creator's name, gender, age, and address registered in association with the respective contents, the audio content generating method including: generating synthesized voice corresponding to said text data registered in said multimedia database by said audio content generation system, generating synthesized voice corresponding to the content attribute information registered in the multimedia database by the audio content generation system, and organizing the synthesized voice corresponding to the text data and the synthesized voice corresponding to the audio data and the content attribute information in accordance with a predetermined order, and generating audio contents which are audible by only audio by the audio content generation system.

According to a sixth aspect of the present invention, there is provided an information exchanging method which uses an audio content generation system connected to a multimedia database in which contents mainly composed of audio data or text data are registered respectively, and a user terminal group connected to the audio content generation system, the information exchanging method including: registering contents mainly composed of audio data or text data in the multimedia database by one user terminal; generating corresponding synthesized voice for the text data registered in the multimedia database by the audio content generation system; generating audio contents in which the synthesized voice corresponding to the text data and the audio data registered in the multimedia database are organized in accordance with a predetermined order by the audio content generation system; and transmitting the audio contents in response to the request of the other user terminal by the audio content generation system, wherein information exchange between the user terminals is actualized by repeating reproduction of the audio contents and additional registration of contents by the audio data or a text format.

According to the present invention, it becomes possible to equally make audio contents for both audio data and text data. More specifically, it becomes possible to actualize an audio blog and Podcasting in which contents or comments, in which audio data and text data are included in mixed manner and data formats are not unified, are appropriately edited and delivered.

In addition, those in which an arbitral combination of the above constituent elements and representation of the present invention are mutually replaced among methods, apparatuses, systems, recording media, computer programs, and the like are also effective as exemplary embodiments of the present invention.

### BRIEF DESCRIPTION OF THE DRAWINGS

The above mentioned object and other objects, features, and advantages will be more apparent from the following description of exemplary embodiments taken in conjunction with the accompanying drawings, in which:

FIG. 1 is a block diagram showing a configuration of an audio content generation system according to first and second exemplary embodiments of the present invention;

FIG. 2 is a flow chart showing the operation of the audio content generation system according to the first exemplary embodiment of the present invention;

FIG. 3 is a block diagram showing a configuration of an audio content generation system according to a third exemplary embodiment of the present invention;

FIG. 4 is a flow chart showing the operation of the audio content generation system according to the third exemplary embodiment of the present invention;

FIG. 5 is a block diagram showing a configuration of an audio content generation system according to a fourth exemplary embodiment of the present invention;

FIG. 6 is a flow chart showing the operation of the audio content generation system according to the fourth exemplary embodiment of the present invention;

FIG. 7 is a block diagram showing a configuration of an audio content generation system according to fifth and sixth exemplary embodiments of the present invention;

FIG. 8 is a flow chart showing the operation of the audio content generation system according to the fifth exemplary embodiment of the present invention;

FIG. 9 is a flow chart showing the operation of the audio content generation system according to the sixth exemplary embodiment of the present invention;

FIG. 10 is a block diagram showing a configuration of an audio content generation system according to a seventh exemplary embodiment of the present invention;

FIG. 11 is a block diagram showing a configuration of an information exchanging system according to an eighth exemplary embodiment of the present invention;

FIG. 12 is a diagram for explaining an audio content generation system according to a first example of the present invention;

FIG. 13 is a diagram for explaining an audio content generation system according to second, seventh, and eighth examples of the present invention;

FIG. 14 is a diagram for explaining auxiliary data according to the second example of the present invention;

FIG. 15 is a diagram for explaining an audio content generation system according to a third example of the present invention;

FIG. 16 is a diagram for explaining a different audio content generation system according to the third example of the present invention;

FIG. 17 is a block diagram showing a configuration of an audio content generation system according to an example derived from other example of the present invention;

FIG. 18 is a flow chart showing an audio content generating method according to the example derived from other example of the present invention;

FIG. 19 is a diagram for explaining an audio content generation system according to a fourth example of the present invention;

FIG. 20 is a diagram for explaining an audio content generation system according to a fifth example of the present invention;

FIG. 21 is a diagram for explaining an audio content generation system according to a sixth example of the present invention;

FIG. 22 is a diagram for explaining a system configuration of an eleventh example of the present invention;

FIG. 23 is a diagram for explaining the operation of the eleventh example of the present invention;

FIG. 24 is a diagram for explaining the operation of the eleventh example of the present invention;

FIG. 25 is a diagram for explaining a modified exemplary embodiment of the eleventh example of the present invention;

FIG. 26 is a block diagram showing a configuration of a multimedia content user interactive unit according to the eighth exemplary embodiment of the present invention; and

FIG. 27 is a block diagram showing a modified exemplary embodiment of a configuration of a multimedia content user interactive unit according to the eighth exemplary embodiment of the present invention.

### BEST MODE FOR CARRYING OUT THE INVENTION

Best modes for implementing the present invention will be described hereinafter with reference to drawings. In addition, the same reference numerals are given to those similar to constituent elements in all the drawings and their detail description will not be repeated.

### First Exemplary Embodiment

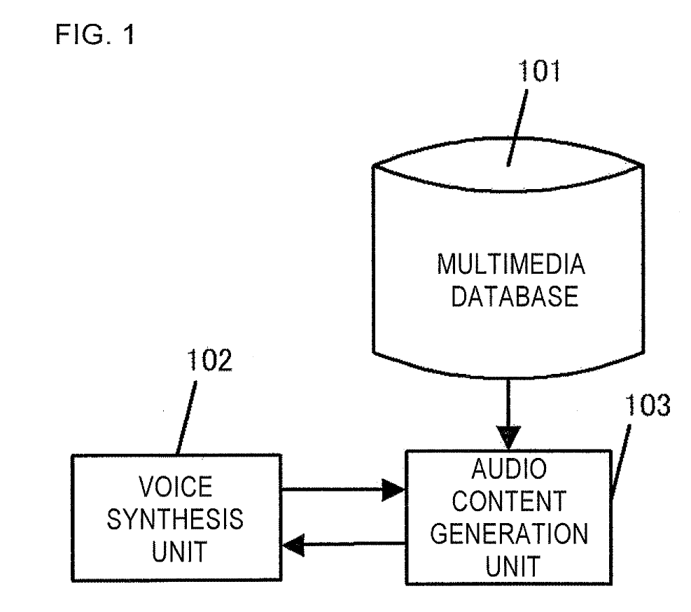

FIG. 1 is a block diagram of an audio content generation system according to a first exemplary embodiment of the present invention. Referring to FIG. 1, the audio content generation system according to the present exemplary embodiment is configured by providing a multimedia database 101, a voice synthesis unit 102, and an audio content generation unit 103. The audio content generation system of the present exemplary embodiment is an audio content generation system including a voice synthesis unit 102 which generates synthesized voice from text; and is provided with an audio content generation unit 103 which is connected to the multimedia database 101 in which contents mainly composed of audio data or text data are registered respectively, generates synthesized voice for the text data registered in the multimedia database 101 by using the voice synthesis unit 102, and generates audio contents in which the synthesized voice and the audio data are organized in accordance with a predetermined order.

Respective constituent elements of the audio content generation system are actualized by arbitrary combination of hardware and software, mainly combined of a central processing unit (CPU) of an arbitrary computer; a memory; a program which actualizes the constituent elements shown in the drawing, loaded in the memory; a memory unit such as a hard disk which stores the program, and an interface for connecting a network. Then, as for methods and apparatuses of actualizing the same, it is to be understood to those skilled in the art that there are many modified exemplary embodiments. Each drawing to be described later is not indicated by a configuration of a hardware unit, but is indicated by a block of a function unit.

The program which actualizes the audio content generation system of the present exemplary embodiment is a program which is executed by a computer (not shown in the drawing), which is connected to the multimedia database 101 in which contents mainly composed of audio data or text data are registered respectively, to execute. The program makes the computer function as the following units of: the voice synthesis unit 102 which generates synthesized voice corresponding to the text data registered in the multimedia database 101; and the audio content generation unit 103 which generates audio contents in which the synthesized voice and the audio data are organized in accordance with a predetermined order.

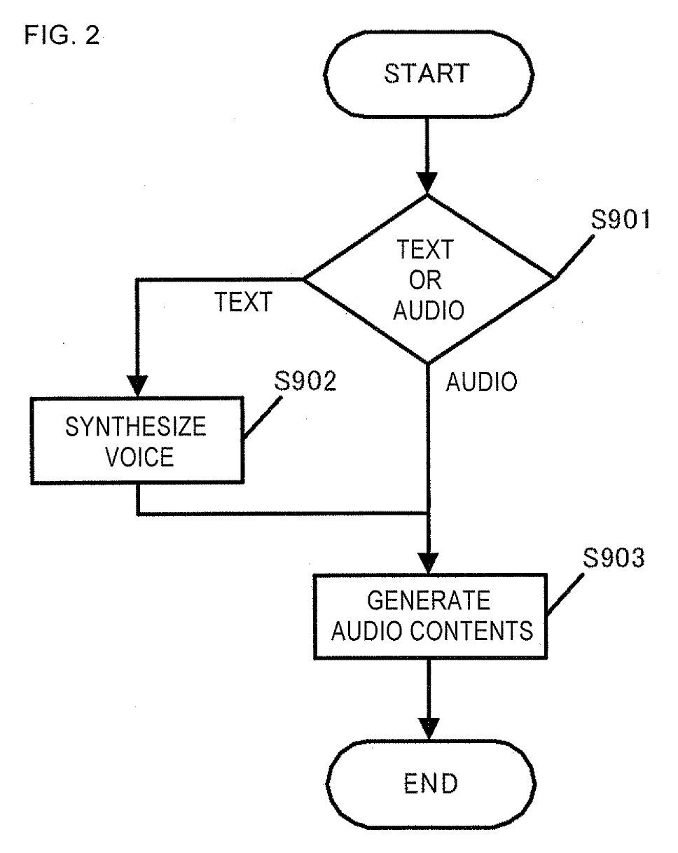

Subsequently, referring to FIGS. 1 and 2, the operation of the present exemplary embodiment will be described. Audio article data made up of at least equal to one or more audio, and text article data made up of at least equal to one or more text are stored in the multimedia database 101.

In step S901, the audio content generation unit 103 reads out article data stored in the multimedia database 101, and judges whether or not the article data is the text article data or the audio article data.

In the case of the text article data, the audio content generation unit 103 outputs the text article data to the voice synthesis unit 102. In step S902, the voice synthesis unit 102 converts the text article data inputted from the audio content generation unit 103 into an audio waveform by text-to-speech synthesis technology (hereinafter, referred to as “voicing” or “making synthesized voice”), and outputs to the audio content generation unit 103. In this case, the text-to-speech synthesis (TTS) technology is a generic name of technology as disclosed in the non-patent document 1, for example, which analyzes inputted text and outputs as synthesized voice by estimating cadence and time length.

In step S903, the audio content generation unit 103 generates contents by using each audio article data stored in the multimedia database 101 and each synthetic tone in which each text article data is voiced in the voice synthesis unit 102.

According to the present exemplary embodiment, it becomes possible to create contents made up of only audio by using data in the multimedia database including mixed audio and text. Therefore, both article data of audio or text can also be delivered in audio. Such audio contents are suitable for use as especially an audio blog and Podcasting.

Furthermore, it is also effective to restrict a range of article data to be selected so as to be fallen within a preliminarily given time or a time range; for example, it becomes possible to control a time in the case where the entire audio content data is simulated as the programs. That is, in the audio content generation system of the present exemplary embodiment, the audio content generation unit 103 may edit the text data and the audio data so that the audio contents are fallen within a predetermined time length.

Furthermore, there may be a configuration excluding the multimedia database 101 from the configuration shown in FIG. 1. The audio content generation system is an audio content generation system provided with a voice synthesis unit 102 which generates synthesized voice from text, and there may be provided with an audio content generation unit 103 which generates synthesized voice for the text data by using the voice synthesis unit 102 from an information source including mixed audio data and text data serves as an input, and generates audio contents in which the synthesized voice and the audio data are organized in accordance with a predetermined order.

### Second Exemplary Embodiment

Subsequently, a second exemplary embodiment of the present invention will be described with reference to drawings. The second exemplary embodiment is such that at least one of presentation order data, audio feature parameters, acoustic effect parameters, and audio time length control data is stored as auxiliary data; each performing control of a presentation order of article data; performing control of audio quality at the time of converting text article data into audio; giving acoustic effect of sound effect, background music (BGM), or the like; and performing control of presentation time length. The present exemplary embodiment can be actualized by the same configuration as the first exemplary embodiment; and therefore, description will be made by using FIG. 1.

In the present exemplary embodiment, at least one of the presentation order data, the audio feature parameters, the acoustic effect parameters, and the audio time length control data is stored in the multimedia database 101 as the auxiliary data. Then, it is characterized that the audio content generation unit 103 performs organization of audio contents by using the auxiliary data.

For example, the audio content generation unit 103 may generate audio contents which read aloud synthesized voice and audio data generated from text data in accordance with the presentation order data preliminarily registered in the multimedia database 101. Alternatively, the audio feature parameters which define an audio feature at the time of converting the text data into audio are registered in the multimedia database 101; the audio content generation unit 103 may read out the audio feature parameters and make the voice synthesis unit 102 generate the synthesized voice by the audio feature using the audio feature parameters.

Further, the multimedia database 101 is registered with the acoustic effect parameters which are given to the synthesized voice generated from the text data; and the audio content generation unit 103 may read out the acoustic effect parameters and give the acoustic effect using the acoustic effect parameters to the synthesized voice generated by the voice synthesis unit 102. Furthermore, the multimedia database 101 is registered with the audio time length control data which defines time length of the synthesized voice generated from the text data; and the audio content generation unit 103 may read out the audio time length control data and make the voice synthesis unit 102 generate synthesized voice having audio time length corresponding to the audio time length control data.

According to the present exemplary embodiment, it becomes possible to change an order which presents the article data, the acoustic feature of audio at the time of generating the audio contents from the text article data, the acoustic effect to be given, and time length at the time of generating the audio contents from the text article data. For this reason, it becomes possible to provide an exemplary embodiment in which the audio contents are easily understood, and there is a little botheration in browsing (listening).

Furthermore, in the audio content generation system of the present exemplary embodiment, the audio content generation unit 103 may generate acoustic effect parameters which indicate at least one of a continuous state of the synthesized voice converted from the text data and the audio data, a difference between the appearance frequency of predetermined words, a difference between the audio quality of the audio data, a difference between the average pitch frequency of the audio data, and a difference between the speech speed of the audio data; and give acoustic effect using the acoustic effect parameters so as to extend between the synthesized voices, between the audio data, or between the synthesized voice and the audio data.

### Third Exemplary Embodiment

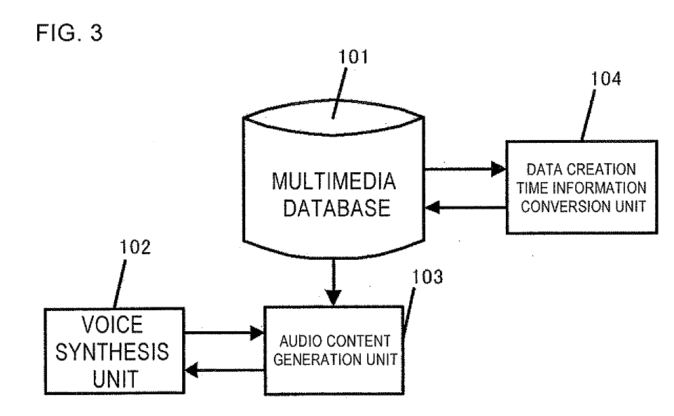

Subsequently, a third exemplary embodiment of the present invention will be described with reference to drawings. FIG. 3 is a block diagram of an audio content generation system according to the third exemplary embodiment of the present invention. Referring to FIG. 3, the audio content generation system according to the present exemplary embodiment includes a data creation time information conversion unit (content attribute information conversion unit) 104 in addition to the above mentioned configurations of the first and the second exemplary embodiments.

The multimedia database 101 has content attribute information (data creation time information) which includes at least one of created date and time, circumstances, the number of past data creations, creator's name, gender, age, and address registered in association with contents mainly composed of audio data or text data. The audio content generation system of the present exemplary embodiment further includes the content attribute information conversion unit (data creation time information conversion unit 104) which makes the voice synthesis unit 102 generate synthesized voice corresponding to the contents of the content attribute information. The audio content generation unit 103 generates audio contents in which attributes of the respective contents are confirmable by the synthesized voice generated by the content attribute information conversion unit (data creation time information conversion unit 104).

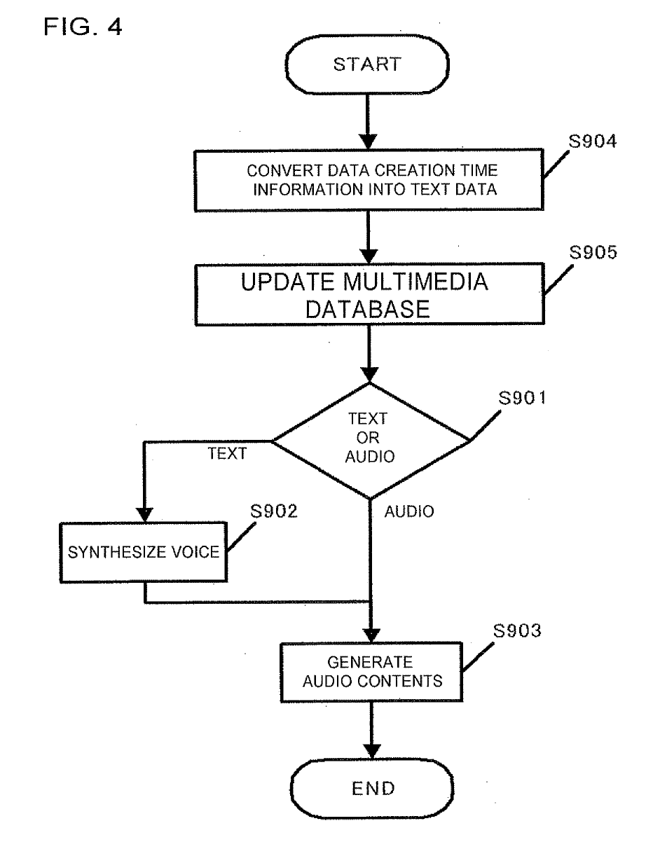

Subsequently, referring to FIGS. 3 and 4, the operation of the present exemplary embodiment will be described. In step S904, the data creation time information conversion unit 104 converts data creation time information in auxiliary data stored in the multimedia database 101 into text article data.

In step S905, the above mentioned converted text article data is stored in the multimedia database 101, and the multimedia database 101 is updated. A subsequent operation is as described in the first exemplary embodiment.

As described above, an audio content generating method of the present exemplary embodiment is an audio content generating method which uses the audio content generation system connected to the multimedia database 101 which may have contents mainly composed of audio data or text data respectively registered therein, and may have content attribute information (data creation time information) which includes at least one of created date and time, circumstances, the number of past data creations, creator's name, gender, age, and address registered in association with the respective contents; and the audio content generating method includes a step (S902) in which the audio content generation system generates synthesized voice corresponding to the text data registered in the multimedia database 101, steps (S904 and S902) in which the audio content generation system generates synthesized voice corresponding to content attribute information (data creation time information) registered in the multimedia database 101, and a step (S903) in which the audio content generation system organizes synthesized voice corresponding to the text data and synthesized voice corresponding to the audio data and the content attribute information in accordance with a predetermined order, and generates audio contents which are audible by only audio.

According to the present exemplary embodiment, the data creation time information (content attribute information) which indicates the attribute corresponding to the respective article data is added, and it becomes possible to give annotation when the respective articles are presented by audio. Therefore, it becomes possible to compensate for a point hard to understand in hearing by audio, for example, information on an article's writer and temporal sequence information.

### Fourth Exemplary Embodiment

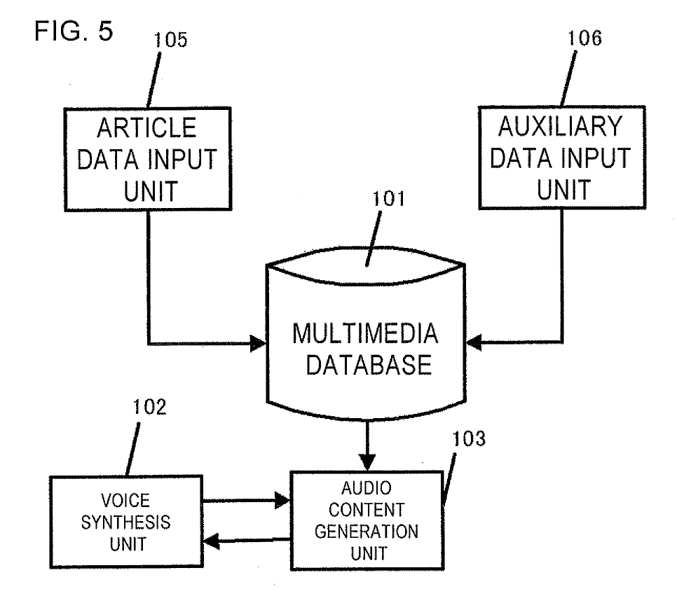

Subsequently, a fourth exemplary embodiment of the present invention will be described with reference to drawings. FIG. 5 is a block diagram of an audio content generation system according to the fourth exemplary embodiment of the present invention. Referring to FIG. 5, the audio content generation system according to the present exemplary embodiment includes an article data input unit 105 and an auxiliary data input unit 106 in addition to reference numerals 101 to 103 shown in FIG. 1 of the above mentioned first and second exemplary embodiments.

That is, the audio content generation system of the present exemplary embodiment further includes a data input unit (auxiliary data input unit 106) which registers contents mainly composed of audio data or text data and presentation order data in the multimedia database 101. Furthermore, the audio content generation system of the present exemplary embodiment further includes a data input unit (auxiliary data input unit 106) which registers contents mainly composed of audio data or text data and audio feature parameters in the multimedia database 101.

Furthermore, the audio content generation system of the present exemplary embodiment includes a data input unit (auxiliary data input unit 106) which registers contents mainly composed of audio data or text data and acoustic effect parameters in the multimedia database 101. Further, the audio content generation system of the present exemplary embodiment includes a data input unit (auxiliary data input unit 106) which registers contents mainly composed of audio data or text data and audio time length control data in the multimedia database 101.

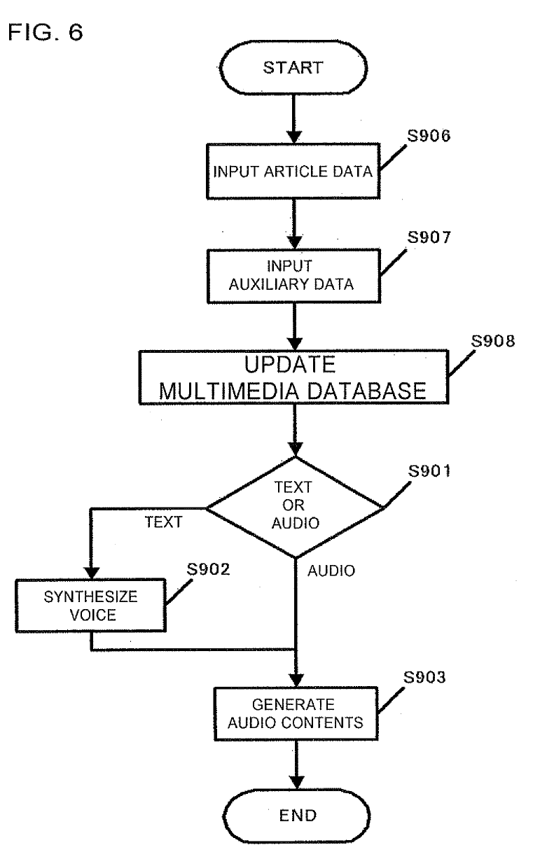

Subsequently, referring to FIGS. 5 and 6, the operation of the present exemplary embodiment will be described. In step S906, the article data input unit 105 inputs audio article data or text article data in the multimedia database 101.

In step S907, the auxiliary data input unit 106 inputs auxiliary data corresponding to the audio article data or the text article data in the multimedia database 101. The auxiliary data in this case is also at least one of the presentation order data, the audio feature parameters, the acoustic effect parameters, and the audio time length control data.

Then, in step S908, the multimedia database 101 is updated. A subsequent operation is as described in the first exemplary embodiment.

According to the present exemplary embodiment, it becomes possible to make a user create the auxiliary data corresponding to the audio article data or the text article data. Therefore, it becomes possible to generate audio contents to which user's intent is correctly reflected and the audio contents with high entertainmentability.

### Fifth Exemplary Embodiment

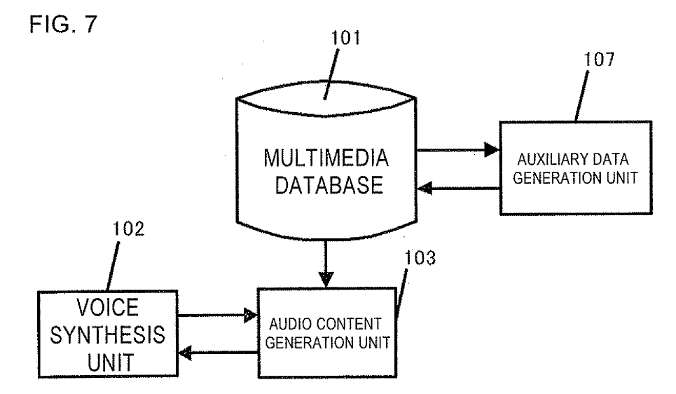

Subsequently, a fifth exemplary embodiment of the present invention will be described with reference to drawings. FIG. 7 is a block diagram of an audio content generation system according to the fifth exemplary embodiment of the present invention. Referring to FIG. 7, the audio content generation system according to the present exemplary embodiment includes an auxiliary data generation unit 107 in addition to the configuration of the above mentioned first and second exemplary embodiments.

That is, the audio content generation system of the present exemplary embodiment further includes a presentation order data generation unit (auxiliary data generation unit 107) which generates the presentation order data on the basis of the audio data or the text data, and wherein the audio content generation unit 103 generates audio contents which reads aloud synthesized voice generated from the text data and the audio data in accordance with the presentation order data. Furthermore, the audio content generation system of the present exemplary embodiment further includes an audio feature parameter generation unit (auxiliary data generation unit 107) which generates audio feature parameters on the basis of the audio data or the text data, and wherein the audio content generation unit 103 makes the voice synthesis unit 102 generate synthesized voice by an audio feature using the audio feature parameters.

Further, the audio content generation system of the present exemplary embodiment further includes an acoustic effect parameter generation unit (auxiliary data generation unit 107) which generates acoustic effect parameters on the basis of the audio data or the text data, and wherein the audio content generation unit 103 gives acoustic effect using the acoustic effect parameters to synthesized voice generated by the voice synthesis unit 102. Furthermore, the audio content generation system of the present exemplary embodiment further includes an audio time length control data generation unit (auxiliary data generation unit 107) which generates the audio time length control data on the basis of the audio data or the text data, and wherein the audio content generation unit 103 makes the voice synthesis unit 102 generate synthesized voice having audio time length corresponding to the audio time length control data.

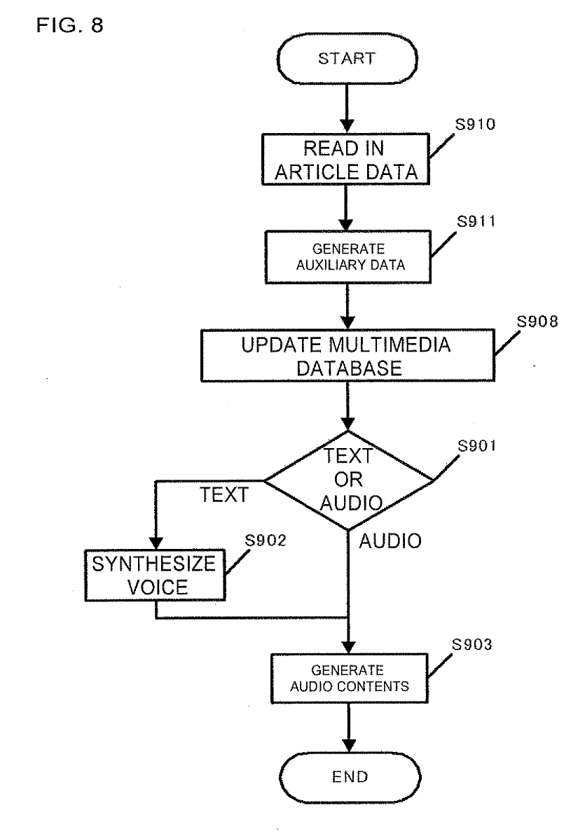

Subsequently, referring to FIGS. 7 and 8, the operation of the present exemplary embodiment will be described. The auxiliary data generation unit 107 reads in audio article data and text article data stored in the multimedia database 101 in step S910; and in step S911, generates auxiliary data from the contents of the article data.

In step S908, the multimedia database 101 is updated by the auxiliary data generation unit 107. A subsequent operation is as described in the first exemplary embodiment.

According to the present exemplary embodiment, it becomes possible to automatically create the auxiliary data on the basis of the contents of data. For this reason, even the auxiliary data is not manually set in each case for the data, it becomes possible to generate audio contents commensurate with the contents of articles and audio contents with high entertainmentability by automatically using the audio feature and the acoustic effect.

More specifically, it is possible to determine acoustic effect to be given between the relevant article data or extending the relevant article data by using characteristics of the article data at the front and back sides in which reproduction order is nearby. This can give acoustic effect of BGM, jingles or the like between the relevant article data or extending therebetween; and therefore, it becomes possible to easily recognize discontinuity in an article and to ginger up atmosphere.

Furthermore, in the audio content generation system of the present exemplary embodiment, the acoustic effect parameter generation unit (auxiliary data generation unit 107) may generate acoustic effect parameters which indicate at least one of a continuous state of the synthesized voice converted from the text data the and audio data, a difference between the appearance frequency of predetermined words, a difference between the audio quality of the audio data, a difference between the average pitch frequency of the audio data, and a difference between the speech speed of the audio data; and are given in a state extending between the synthesized voices, between the audio data, or between the synthesized voice and the audio data.

### Sixth Exemplary Embodiment

Subsequently, a sixth exemplary embodiment of the present invention will be described with reference to drawings. The present exemplary embodiment can be actualized by the same configuration as in the fifth exemplary embodiment. The audio content generation system of the present exemplary embodiment is different from the fifth exemplary embodiment in that the auxiliary data generation unit 107 generates auxiliary data on the basis of data creation time information (content attribute information).

That is, the audio content generation system of the present exemplary embodiment further includes a presentation order data generation unit (auxiliary data generation unit 107) which generates the presentation order data on the basis of the content attribute information (data creation time information), and wherein the audio content generation unit 103 generates audio contents which reads aloud synthesized voice generated from the text data and the audio data in accordance with the presentation order data. Furthermore, the audio content generation system of the present exemplary embodiment includes an audio feature parameter generation unit (auxiliary data generation unit 107) which generates audio feature parameters on the basis of the content attribute information (data creation time information), and wherein the audio content generation unit 103 makes the voice synthesis unit 102 generate synthesized voice by an audio feature using the audio feature parameters.

Further, the audio content generation system of the present exemplary embodiment further includes an acoustic effect parameter generation unit (auxiliary data generation unit 107) which generates acoustic effect parameters on the basis of the content attribute information (data creation time information), and the audio content generation unit 103 gives acoustic effect using the acoustic effect parameters to synthesized voice generated by the voice synthesis unit 102. Furthermore, the audio content generation system of the present exemplary embodiment further includes an audio time length control data generation unit (auxiliary data generation unit 107) which generates audio time length control data on the basis of the content attribute information (data creation time information), and the audio content generation unit 103 makes the voice synthesis unit 102 generate synthesized voice having audio time length corresponding to the audio time length control data.

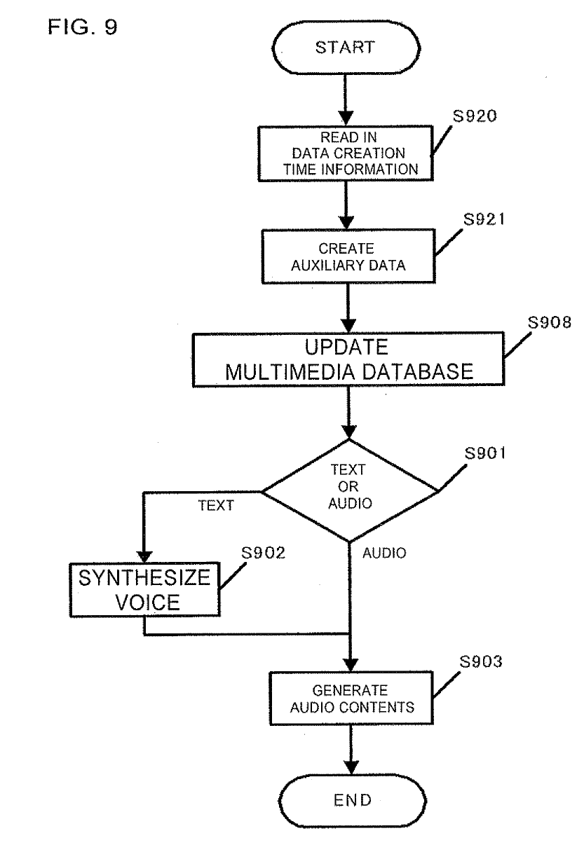

Hereinafter, the operation thereof will be described with reference to FIGS. 7 and 9. Referring to FIG. 9, the auxiliary data generation unit 107 reads in data creation time information stored in the multimedia database 101 in step S920; and in step S921, the auxiliary data is created from the data creation time information. A subsequent operation is as described in the fifth exemplary embodiment.

According to the present exemplary embodiment, it becomes possible to generate the above mentioned auxiliary data by using the data creation time information. For example, audio conversion is performed by using writer's attribute information of each article data, and it becomes possible to be easily understood.

### Seventh Exemplary Embodiment

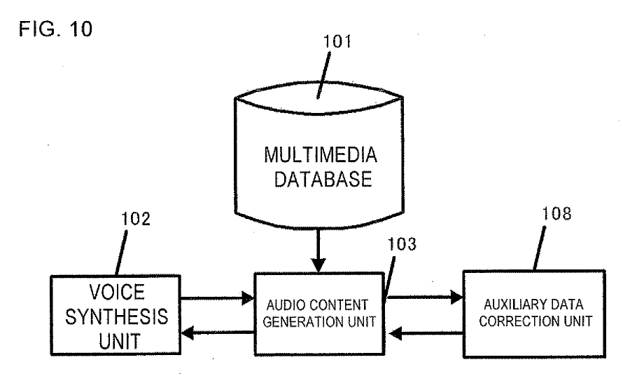

Subsequently, a seventh exemplary embodiment of the present invention will be described with reference to drawings. FIG. 10 is a block diagram of an audio content generation system according to the seventh exemplary embodiment of the present invention. Referring to FIG. 10, an audio content generation system according to the present exemplary embodiment includes an auxiliary data correction unit 108 in addition to the configurations of the above mentioned first and second exemplary embodiments.

Then, the auxiliary data correction unit 108 uses auxiliary data related to article data which is earlier article data to be processed, and corrects the auxiliary data related to the article data.

That is, the audio content generation system of the present exemplary embodiment includes a presentation order data correction unit (auxiliary data correction unit 108) which automatically corrects presentation order data in accordance with predetermined rules. Furthermore, the audio content generation system of the present exemplary embodiment includes an audio feature parameter correction unit (auxiliary data correction unit 108) which automatically corrects audio feature parameters in accordance with predetermined rules.

Further, the audio content generation system of the present exemplary embodiment includes an acoustic effect parameter correction unit (auxiliary data correction unit 108) which automatically corrects acoustic effect parameters in accordance with predetermined rules. Furthermore, the audio content generation system of the present exemplary embodiment includes an audio time length control data correction unit (auxiliary data correction unit 108) which automatically corrects audio time length control data in accordance with predetermined rules.

According to the present exemplary embodiment, it becomes possible to correct the above mentioned auxiliary data in line with the auxiliary data related to the article data to be outputted prior to the relevant article data. This can automatically generate appropriate audio contents which do not disrupt atmosphere and flow in the corresponding audio contents. Furthermore, according to the present exemplary embodiment, there is eliminated a problem in which a balance of the entire contents is disrupted if audio quality and the way of speaking of respective comments are different in the case where a plurality of comments are attached to contents by audio.

### Eighth Exemplary Embodiment

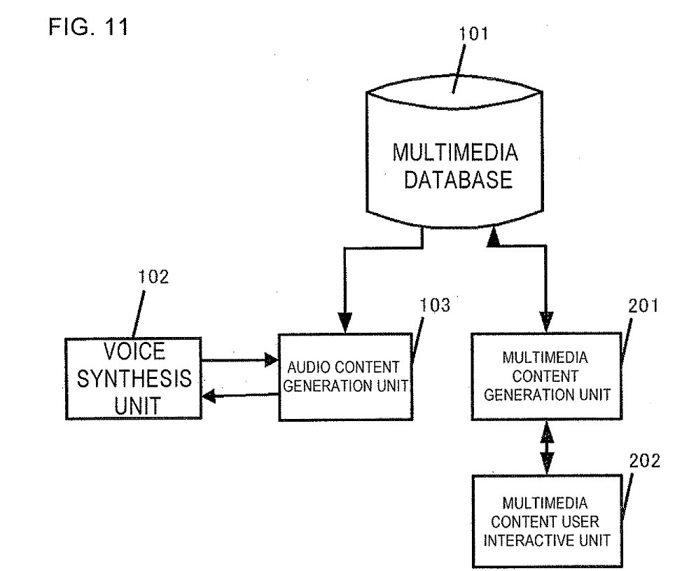

Subsequently, an eighth exemplary embodiment of the present invention will be described with reference to drawings. FIG. 11 is a block diagram of an information exchanging system according to the eighth exemplary embodiment of the present invention. Referring to FIG. 11, the information exchanging system according to the present exemplary embodiment includes a multimedia content generation unit 201 and a multimedia content user interactive unit 202 in addition to the configurations of the first and second exemplary embodiments.

In accordance with a user's operation, the multimedia content user interactive unit 202 reads out article data from the multimedia database 101 and presents in a message list format; and at the same time, the number of respective data to be browsed, history of user operation, and the like are recorded in the multimedia database 101.

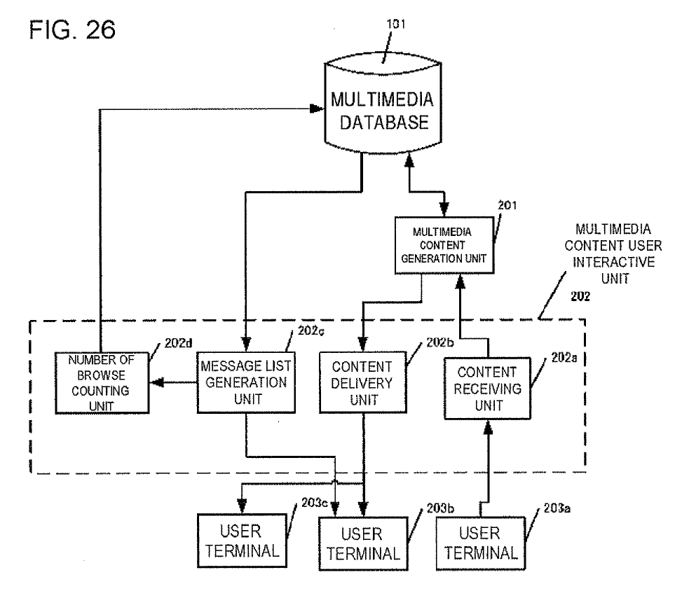

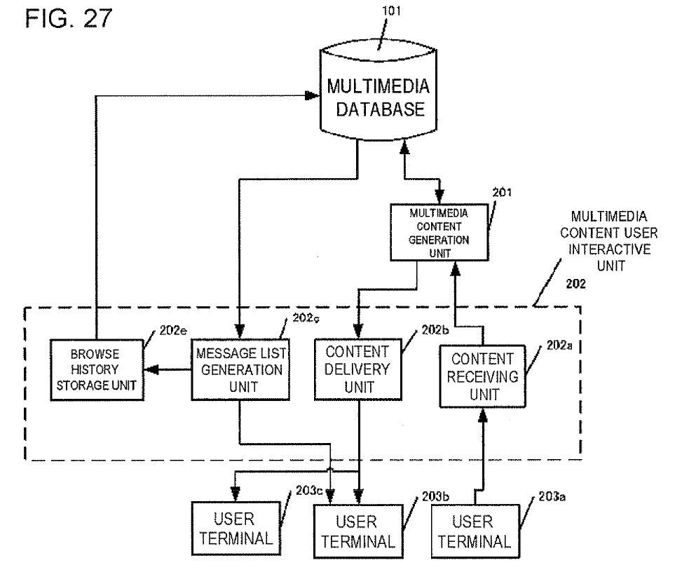

A configuration example of the multimedia content user interactive unit 202 will be described using FIGS. 26 and 27. A multimedia content user interactive unit 202 shown in FIG. 26 includes a content receiving unit 202a, a content delivery unit 202b, a message list generation unit 202c, and a counting unit of the number of browse 202d. A multimedia content user interactive unit 202 shown in FIG. 27 includes a browse history storage unit 202e in place of the counting unit of the number of browse 202d shown in FIG. 26.

The content receiving unit 202a receives contents from a user terminal 203a and outputs to the multimedia content generation unit 201. The content delivery unit 202b delivers multimedia contents generated by the multimedia content generation unit 201 to user terminals 203b and 203c. The message list generation unit 202c reads out an article list of the multimedia database 101, creates a message list, and outputs to the user terminal 203b which requires the message list. The counting unit of the number of browse 202d counts the number in which the multimedia contents are browsed and reproduced and outputs a counted result to the multimedia database 101 on the basis of the message list. Furthermore, on the basis of the message list, the browse history storage unit 202e stores an order or the like in which respective articles in the multimedia contents are browsed and outputs to the multimedia database 101.

According to the present exemplary embodiment, the number of browses of the above mentioned data and user's browse history or the like are reflected on auxiliary data; and accordingly, it becomes possible to provide audio contents, in which the user's browse history of the multimedia contents is reflected, to a listener of the audio contents in which a feedback unit is scanty.

The information exchanging system of the exemplary embodiment of the present invention is an information exchanging system which includes the audio content generation system of the above mentioned exemplary embodiment and is used for information exchange between a plurality of user terminals 203a to 203c, the information exchanging system including a unit (content receiving unit 202a) which accepts registration of text data or audio data from one user terminal 203a to a multimedia database 101; and a unit (content delivery unit 202b) which transmits the audio contents generated by the audio content generation unit 103 to user terminals 203b and 203c which require service by audio, and wherein information exchange between the respective user terminals is actualized by repeating reproduction of the transmitted audio contents and additional registration of contents by the audio data or a text format.

The above mentioned information exchanging system further includes a unit (message list generation unit 202c) which generates a message list for browsing and listening the text data or the audio data registered in the multimedia database 101, and presents the message list to user terminals 203b and 203c to be accessed; and a unit (counting unit of the number of browse 202d) which counts the number of browses and the number of reproductions of the respective data based on the message list, respectively, and wherein the audio content generation unit 103 may generate audio contents which reproduce text data and audio data in which the number of browses and the number of reproductions are equal to or more than a predetermined value.

Further, the above mentioned information exchanging system further includes a unit (message list generation unit 202c) which generates a message list which is for browsing and listening text data or audio data registered in the multimedia database 101, and presents the message list to user terminals 203b and 203c to be accessed; and a unit (browse history storage unit 202e) which records browse history of each data based on the message list for each user, and the audio content generation unit 103 may generate audio contents which reproduce text data and audio data in accordance with an order pursuant to browse history of an arbitrary user designated from the user terminals.

Further, in the above mentioned information exchanging system, data to be registered in the multimedia database are weblog article contents composed of text data or audio data, and the audio content generation unit 103 arranges the weblog article contents of a weblog establisher at the top in a registration order, and may generate audio contents in which comments registered from other user are arranged in accordance with predetermined rules.

Furthermore, the information exchanging method of the present exemplary embodiment is an information exchanging method which uses an audio content generation system connected to a multimedia database 101 in which contents mainly composed of audio data or text data are registered respectively, and a user terminal group connected to the audio content generation system, the information exchanging method including: registering contents mainly composed of audio data or text data in the multimedia database 101 by one user terminal; generating corresponding synthesized voice for the text data registered in the multimedia database 101 by the audio content generation system; generating audio contents in which the synthesized voice corresponding to the text data and the audio data registered in the multimedia database 101 are organized in accordance with a predetermined order by the audio content generation system; and transmitting the audio contents in response to the request of the other user terminal by the audio content generation system, wherein information exchange between the user terminals is actualized by repeating reproduction of the audio contents and additional registration of contents by the audio data or a text format.

### Example

### Example 1

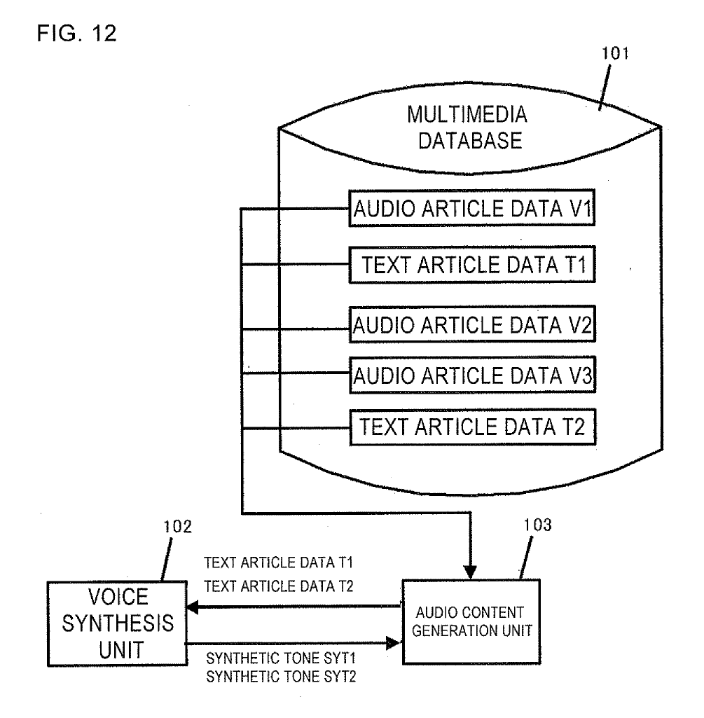

Subsequently, a first example of the present invention corresponding to the above mentioned first exemplary embodiment will be described. Hereinafter, description will be made in detail with reference to FIG. 12 which shows an outline of the present example.

At least equal to one or more audio and at least equal to one or more text are preliminarily stored in a multimedia database 101. The contents of the audio or the text are articles, which are each referred as audio article data or text article data, and are generally referred as article data.

In this case, audio article data V1 to V3 and text article data T1 and T2 are stored in the multimedia database 10, respectively.

An audio content generation unit 103 sequentially reads out the article data from the multimedia database 101.

Next, processing is divided depending on whether the relevant article data is the audio article data or the text article data. In the case of the audio article data, audio of the contents is directly used; however, in the case of the text article data, the text article data is once sent to a voice synthesis unit 102, voiced by speech synthesis process, and then returned to the audio content generation unit 103.

In the present example, first, the audio content generation unit 103 reads out audio article data V1 from the multimedia database 101.

Next, the audio content generation unit 103 reads out the text article data T1 and sends to the voice synthesis unit 102, because the text article data T1 is the text article data.

In the voice synthesis unit 102, the aforementioned sent text article data T1 is made into synthesized voice by text-to-speech synthesis technology.

In this case, acoustic feature parameters indicate values which determine audio quality of synthetic tone, cadence, time length, pitch of voice, the entire speech speed, and the like. According to the text-to-speech synthesis technology, by using these acoustic feature parameters, synthetic tone having a feature thereof can be generated.

By the voice synthesis unit 102, the text article data T1 is voiced to be synthetic tone SYT1, and outputted to the audio content generation unit 103.

After that, the audio content generation unit 103 performs the same processing in the order corresponding to the audio article data V2 and V3, and the text article data T2; and obtains in the order corresponding to the audio article data V2 and V3, and synthetic tone SYT2.

The audio content generation unit 103 generates audio contents by combining each audio so as to be reproduced in the order corresponding to V1→SYT1→V2→V3→SYT2.

### Example 2

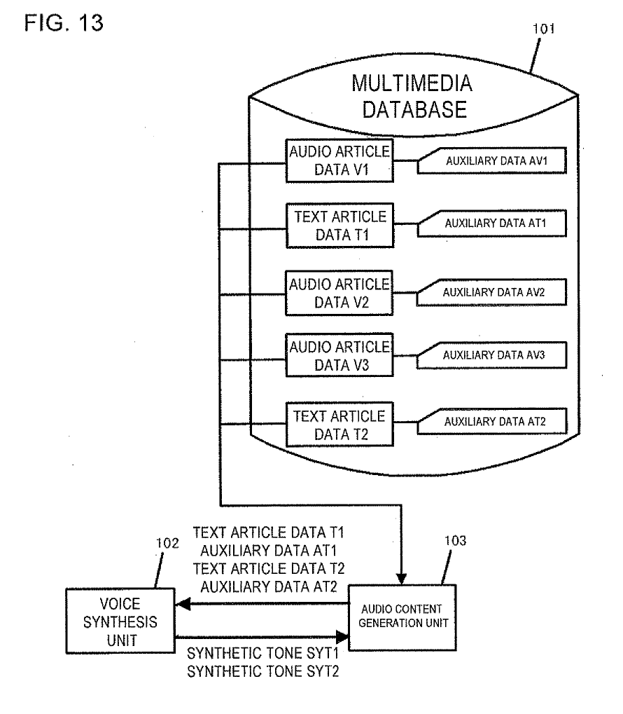

Subsequently, a second example of the present invention corresponding to the above mentioned second exemplary embodiment will be described. Hereinafter, description will be made in detail with reference to FIG. 13 which shows an outline of the present example.

At least equal to one or more audio article data and at least equal to one or more text article data are preliminarily stored in a multimedia database 101. Furthermore, auxiliary data is stored in the multimedia database 101 for the respective article data.

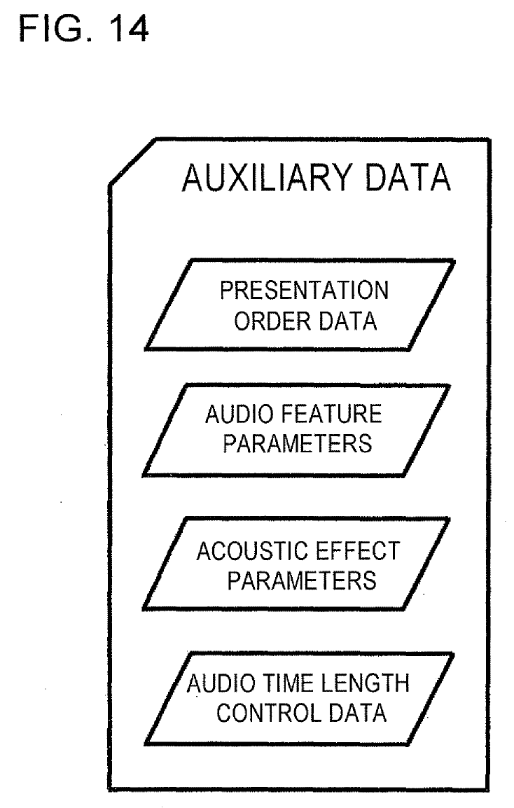

The auxiliary data includes equal to one or more of presentation order data, audio feature parameters, acoustic effect parameters, and audio time length control data, as shown in FIG. 14.

The presentation order data indicates an order in which the respective article data are stored in the audio contents; in other words, an order to be presented at the time of listening.

The audio feature parameters are parameters showing a feature of synthesized voice, and includes at least one of audio quality of synthetic tone, the entire tempo and the pitch of voice, cadence, intonation, power, local continuous time length and pitch frequency, and the like.

The acoustic effect parameters are parameters which are for giving acoustic effect to synthetic tone in which the audio article data and the text article data are voiced; and the acoustic effect includes at least one of all audio signals such as background music (BGM), interlude music (jingle), sound effect, fixed dialogue, and the like.

The audio time length control data is data which is for controlling time length in which synthetic tone, in which the audio article data and the text article data are voiced, is reproduced in the contents.

In the present example, the auxiliary data is delimited therein by fields; and it is regarded as that the presentation order, the audio feature parameters, the acoustic effect parameters, and the audio time length control data are described; and unnecessary parameters are not described. Hereinafter, for the sake of explanation, description will be made that it is regarded as that any one of the above mention is described in the auxiliary data.

In this case, first, there will be described a case where the contents of the auxiliary data is the presentation order data. As an example, it is regarded as that audio article data V1 to V3, text article data T1 and T2, presentation order data AV1 to AV3 corresponding to each of the audio article data V1 to V3, and presentation order data AT1 and AT2 corresponding to each of the text article data T1 and T2 are stored in the multimedia database 101.

Order in which V1 to V3, T1, and T2 that are the respectively corresponding article data are to be stored in the audio contents, in other words, order to be presented at the time of listening is described in the presentation order data AV1 to AV3, AT1, and AT2.

As for a description format of the presentation order data, there is a method which stores data names to be presented at the front and back sides of the data and information showing the data is the head or the end. In this case, it is regarded as that the presentation order data is stored so as to be a reproduction order of V1→T1→V2→V3→T2.

An audio content generation unit 103 reads out the respective presentation order data from the multimedia database 101, recognizes the presentation order, and reads out the relevant article data from the multimedia database 101 in accordance with the presentation order.

Also in this case, processing is divided depending on whether the relevant article data is the audio article data or the text article data. That is, in the case of the audio article data, the audio article data is directly used; however, in the case of the text article data, the text article data is once sent to a voice synthesis unit 102, voiced by speech synthesis process, and then returned to the audio content generation unit 103.

In the present example, in accordance with information of the auxiliary data AV1, first, the audio article data V1 is outputted from the multimedia database 101 to the audio content generation unit 103.

Next, in accordance with information of the auxiliary data AT1, the text article data T1 is outputted to the audio content generation unit 103 and sent to the voice synthesis unit 102, because the text article data T1 is the text article data. In the voice synthesis unit 102, the aforementioned sent text article data T1 is made into synthesized voice by text-to-speech synthesis technology.

The text article data T1 is voiced to be synthetic tone SYT1, and outputted to the audio content generation unit 103.

After that, there is performed the same processing in the order corresponding to the audio article data V2 and V3, and the text article data T2; and then, outputted to the audio content generation unit 103 in the order corresponding to the audio article data V2 and V3, and synthetic tone SYT2.

The audio content generation unit 103 generates the audio contents by combining data so as to be reproduced in the order corresponding to V1→SYT1→V2→V3→SYT2, which is shown by the respective presentation order data.

In the above mentioned example, the audio article data V1 to V3, the text article data T1 and T2, and the auxiliary data AV1 to AV3, AT1, and AT2 are decentrally stored in the multimedia database 101; however, there is conceivable a method in which storage is made as a data set in which the above mentioned data group is conflated and a plurality of the data sets are stored.

Besides, in the above mentioned example, one auxiliary data is provided for the multimedia database 101, and the reproduction order may be recorded in block. In this case, the reproduction order of V1→T1→V2→V3→T2 is recorded in the auxiliary data.

Furthermore, there is a case where random access cannot be performed depending on the types of the multimedia database. In this case, even the reproduction order is not designated by the auxiliary data, the reproduction order is determined by sequentially reading out the respective article data from the multimedia database.

In addition, it is not necessary that the auxiliary data is provided for all data, and there may be a configuration in which one auxiliary data is provided for the entire multimedia databases.

Next, there will be described a case where the auxiliary data is audio feature parameters. As an example, there is considered a case that the audio feature parameters are included in the auxiliary data AT1 corresponding to the text article data T1.

When the text article data T1 is voiced to be the synthetic tone SYT1 in the voice synthesis unit 102, the audio content generation unit 103 sends the audio feature parameters AT1 to the voice synthesis unit 102 together with the text article data T1, and determines a feature of the synthetic tone by using the audio feature parameters AT1. The text article data T2 and the audio feature parameters AT2 are also treated in the same manner.

As for a description format of the audio feature parameters, a format which sets the parameters in numeric value is conceivable. For example, it is regarded as that the entire tempo Tempo and the pitch of voice Pitch may be designated in numeric value as the audio feature parameters, and the audio feature parameters of {Tempo=100, Pitch=400} are given to the auxiliary data AT1 and the audio feature parameters of {Tempo=120, Pitch=300} are given to the auxiliary data AT2.

In this case, in the voice synthesis unit 102, there are generated the synthetic tones SYT1 and SYT2 having the following features: SYT2 has a speech speed that is 1.2 times as compared with that of SYT1, and a pitch of voice that is 0.75 times as compared with that of SYT1.

As described above, the feature of the synthetic tone is made to change; and accordingly, it becomes possible to differentiate the text article data T1 and T2 when generated contents are listened by audio.

Furthermore, as a description format of the audio feature parameters, a format which selects preliminarily given parameters is also conceivable. For example, it is regarded as that parameters which are for reproducing characters having features of a character A, a character B, and a character C are preliminarily prepared, and the multimedia database 101 is made to store as ChaA, ChaB, and ChaC, respectively.

Then, it is regarded as that parameters which reproduce characters may be designated by Char as the acoustic effect parameters, and parameters of {Char=ChaC} are given to the auxiliary data AT1, and parameters of {Char=ChaA} are given to the auxiliary data AT2.

In this case, the synthetic tones, in which SYT1 has a feature of the character C and SYT2 has a feature of the character A, are outputted in the voice synthesis unit 102. As described above, the preliminarily given characters are selected; and accordingly, the synthetic tones having specific features can be easily generated, and it becomes possible to reduce information volume in the auxiliary data.

Next, there will be described a case where the auxiliary data is the acoustic effect parameters. As an example, there is considered a case that the acoustic effect parameters are included in the auxiliary data AV1 to AV3 corresponding to each of the audio article data V1 to V3 and in the auxiliary data AT1 and AT2 corresponding to each of the text article data T1 and T2. Acoustic effect is preliminarily stored in the multimedia database 101.

The audio content generation unit 103 generates the audio article data V1 to V3 on which the acoustic effect shown in the acoustic effect parameters is superimposed, and the audio contents which reproduces the synthetic tones SYT1 and SYT2.

As a description format of the acoustic effect parameters, there is also conceivable a format which preliminarily sets a value peculiar to each acoustic effect and directs the above mentioned value in the auxiliary data.

In this case, it is regarded as that background music MusicA, MusicB, sound effect SoundA, Sounds, and SoundC are stored in the multimedia database 101; and as the acoustic effect parameters, the background music may be set by BGM and the sound effect may be set by SE. For example, if it is regarded as that parameters such as {BGM=MusicA, SE=SoundB}, {BGM=MusicB, SE=SoundC}, . . . are given to each of the auxiliary data AV1 to AV3, AT1, and AT2; the acoustic effect set in the audio article data V1 to V3 and the synthetic tones SYT1 and SYT2 are superimposed in the audio content generation unit 103, and consequently the audio contents are generated.

It is also, of course, possible to superimpose either the background music or the sound effect, or not to superimpose both of them.

It is also conceivable that absolute or relative time information which superimposes the acoustic effect is given as the acoustic effect parameters. In doing so, it is possible to superimpose the acoustic effect at arbitral timing.

Furthermore, it is also conceivable that sound volume of the acoustic effect is given as the acoustic effect parameters. In doing so, sound volume of the jingle may be designated depending on the contents of article, for example.

Next, there will be described a case where the auxiliary data is audio time length control data. In this case, the audio time length control data indicates data which is for changing the audio article data, the text article data, or the synthetic tone so as to be the time length specified by the audio time length control data in the case where the time length of the audio article data and the synthetic tone exceeds the time length specified by the audio time length control data.

For example, it is regarded as that the audio article data V1 and the synthetic tone SYT1 are 15 sec and 13 sec, respectively; and there is description that the audio time length control data is {Dur=10 [sec]}. In this case, data exceeding 10 sec is deleted so that the time lengths of V1 and SYT1 become 10 sec in the audio content generation unit 103.

Besides, in place of the above mentioned method, a method which accelerates the speech speed may also be adopted so that the time lengths of V1 and SYT1 become 10 sec. It is conceivable that the method which accelerates the speech speed uses a “Pointer Interval Controlled OverLap and Add” (PICOLA) method. Further, parameters of the speech speed may be calculated so that the time length of SYT1 becomes 10 sec at a stage of synthesizing in the voice synthesis unit 102, and then synthesized.

Furthermore, the audio time length control data may give a range made up of a pair of the minimum time length and the maximum time length to be reproduced in place of giving the maximum time length to be reproduced. In this case, in the case of being shorter than the given minimum time length, processing which decelerates the speech speed is performed.

In addition, in the case where 0 or a negative time length is given in the audio time length control data, for example, in the case of {Dur=0}, it is also possible to control so as not to be reproduced in the audio contents.

In doing as described in the present example, the time length of audio may be changed depending on importance or the like; and therefore, it becomes possible to prevent botheration in listening due to too long audio contents.

In the above mentioned example, the parameters and the acoustic effect preliminarily given by the audio feature parameters are stored in the multimedia database 101; however, the parameters may be stored in databases DB2 and DB3 by providing a configuration in which different databases DB2 and DB3 are added respectively. Further, DB2 and DB3 may be the same databases.

### Example 3

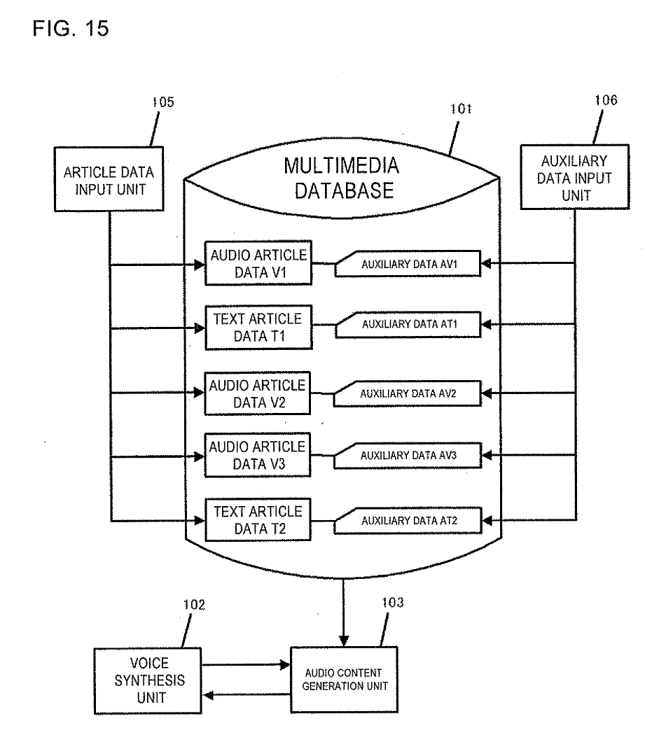

Subsequently, a third example of the present invention corresponding to the above mentioned fourth exemplary embodiment will be described. Hereinafter, description will be made with reference to FIG. 15 showing an outline of the present example.

Audio and text article data to be stored in a multimedia database 101 are inputted in an article data input unit 105.

Auxiliary data corresponding to the audio and the text article data inputted in the article data input unit 105 are inputted in an auxiliary data input unit 106. The auxiliary data is any of the aforementioned presentation order data, audio feature parameters, acoustic effect parameters, and audio time length control data.

Audio contents are generated in the audio content generation unit 103 as described in the example 1 and the example 2 by using data and the auxiliary data stored in the multimedia database 101.

For example, a data typist inputs the audio article data by using the article data input unit 105. The audio may be inputted by connecting a microphone and recording.

After that, the data typist inputs audio time length control data corresponding to the audio article data is set as Dur={15 [sec]} by using the auxiliary data input unit 106.

According to the present example, the auxiliary data can be inputted as the data typist pleases, and the contents can be generated freely.

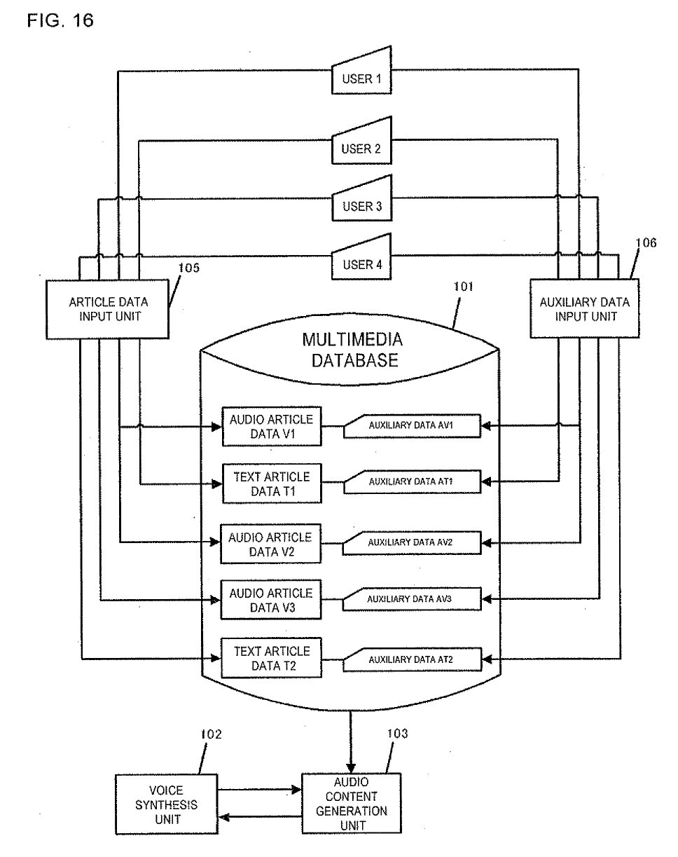

Besides, the audio article data and the text article data may be created by separate users. For example, as shown in FIG. 16, there is conceivable a case where a user 1 inputs audio article data V1 and V2; a user 2 inputs text article data T1; a user 3 inputs audio article data V3; a user 4 inputs text article data T2; and the respective users input AV1 to AV3, AT1, and AT2 as corresponding auxiliary data, respectively.

Furthermore, a data typist who inputs data may be different from a data typist who inputs the auxiliary data corresponding to the relevant data. With this, a user A inputs an original article in a blog, a different user B inputs comments to the original article, and the user A further inputs comments of reply to the inputted comments; and then, audio blog contents in which they are put together can be easily created.

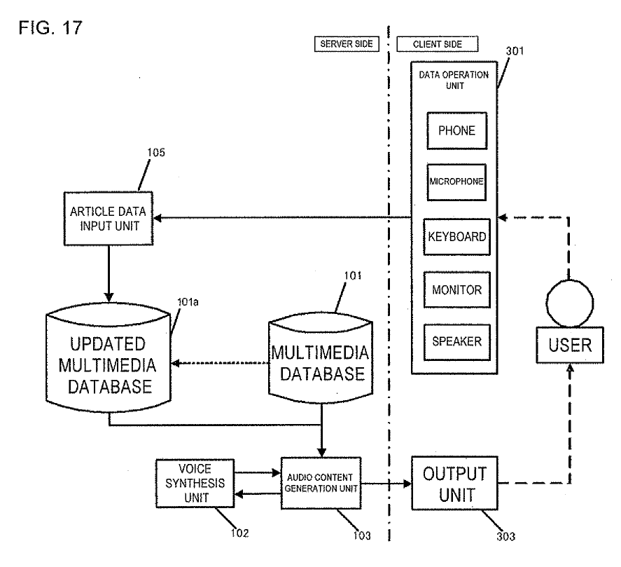

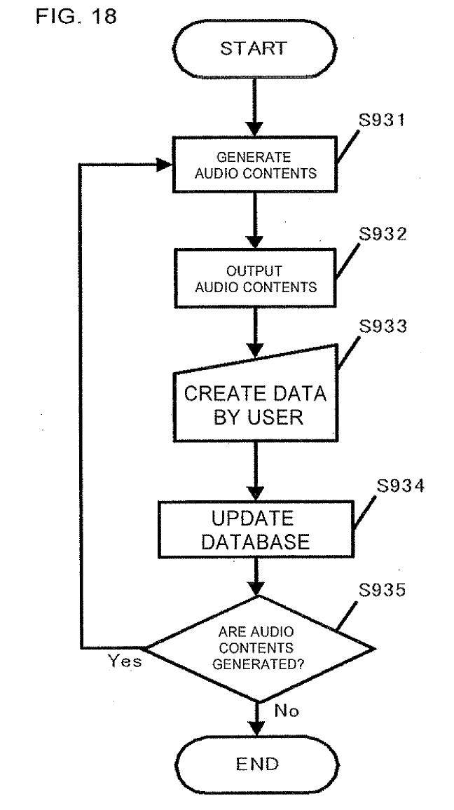

In addition, as a different example derived from the aforementioned third example, a method in which audio contents generated by an audio content generation unit 103 are outputted, and a user who listened the audio contents operates data will be described by using a block diagram shown in FIG. 17 and a flow chart shown in FIG. 18.

The audio content generation unit 103 generates the audio contents (step S931 shown in FIG. 18); and the generated audio contents are outputted in an output unit 303 so that a user can listen (step S932 shown in FIG. 18).

A personal computer, a mobile phone, a headphone and a speaker connected to an audio player, and the like are conceivable as the output unit 303.

The user who listened the audio contents creates audio article data or text article data in a data operation unit 301, and the created article data is sent to an article data input unit 105 (step S933 shown in FIG. 18).

In the data operation unit 301, at least one of a phone (the transmission side), a microphone, a keyboard, and the like is included as an input unit of the audio article data and the text article data; and at least one of the phone (the reception side), a speaker, a monitor, and the like is included as a unit for confirming the inputted audio article data and the text article data.

The output unit 303 and the data operation unit 301 may be arranged at a place apart from the multimedia database 101, a voice synthesis unit 102, the audio content generation unit 103, and the article data input unit 105; for example, the former is arranged near the user (referred to as the client side) and the latter are arranged in a Web server (referred to as the server side).

The inputted data is stored (step S934 shown in FIG. 18) in multimedia databases (101 and 101a shown in FIG. 17); and contents to which new data are added are generated (S931 shown in FIG. 18) by user's designation or a predetermined operation of the system (Yes at step S935 shown in FIG. 18).

The generated contents are further outputted to the user, and it becomes possible to perform repetition process of creation of user data, database update, new audio content generation.

With this configuration, the user can listen the audio contents and input comments with respect to the above mentioned contents as the audio article data or the text article data, and the above mentioned data are stored in the multimedia databases (101 and 101a shown in FIG. 17); and accordingly, new contents can be generated.

Furthermore, there is conceivable a case where there exist a plurality of users (not shown in the drawing). First, it is regarded as that a user 1 inputs an audio article data V1 in a multimedia database 101, and audio contents C1 are generated.

Next, a user 2, a user 3, and a user 4 listen the audio contents C1 respectively; the user 2 and the user 3 create audio article data V2 and V3, respectively; and the user 4 creates text article data T4. The data 72, V3, and T4 are stored to the multimedia database 101 via an article data input unit 105; and new contents C2 are generated by using V1, V2, V3, and T4.

In addition, it is preferable that the multimedia database 101 has a function which prevents competition of a plurality of users.

With such a configuration, it becomes possible that the audio article data and the text article data created by the plurality of users are combined to be one content.

Further, in this case, in the above mentioned data at the time of data creation, there may be included data such as date and time when the contents are browsed, date and time when the comments are posted, the number of past comments of a relevant comment poster, and the whole number of comments posted to relevant contents.

### Example 4

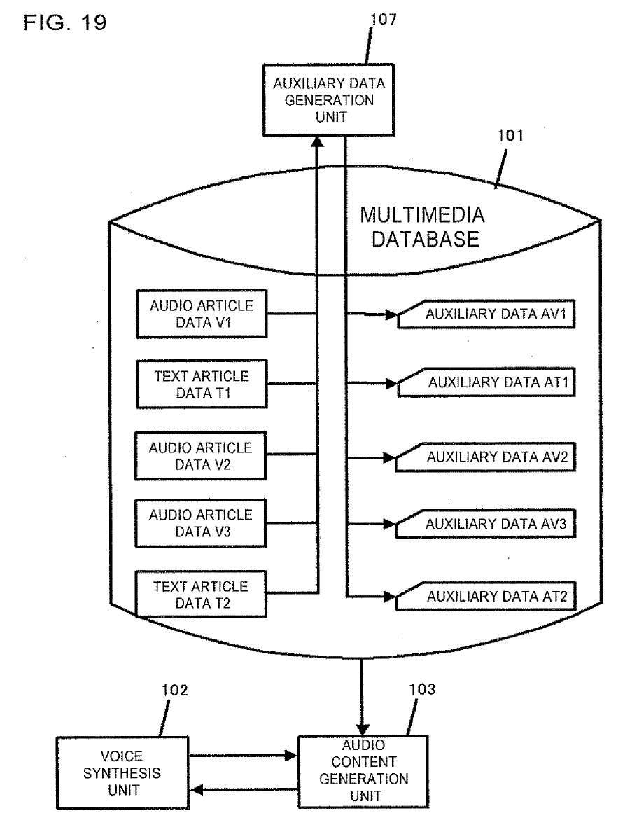

Subsequently, a fourth example of the present invention corresponding to the above mentioned fifth exemplary embodiment will be described. Hereinafter, description will be made in detail with reference to FIG. 19 showing an outline of the present example.

In the present example, a multimedia database 101, a voice synthesis unit 102, and an audio content generation unit 103 have the same functions as reference numerals 101 to 103 shown in the abovementioned first and second examples.

An auxiliary data generation unit 107 generates corresponding auxiliary data from the contents of audio article data and text article data stored in the multimedia database 101.

In this case, the auxiliary data are presentation order data, audio feature parameters, acoustic effect parameters, and audio time length control data.

In the case where the article data is the audio article data, a pair of a keyword and auxiliary data corresponding thereto is preliminarily registered. This pair makes acoustic effect parameters “sound effect=laughter” correspond to a keyword “delightful,” for example.

The auxiliary data generation unit 107 detects whether or not the aforementioned preliminarily determined keyword is included from the audio article data by using, for example, keyword spotting that is one of speech recognition technology.

In this case, when the keyword is detected, the auxiliary data generation unit 107 generates the relevant auxiliary data and registers.

Besides, it is also possible to adopt a method for detecting the aforementioned keyword by once converting into text by speech recognition in place of the above mentioned method.

Furthermore, in the case where an acoustic feature such as power of the audio article data exceeds a predetermined threshold, the auxiliary data may be combined. For example, in the case where the maximum amplitude of an audio waveform exceeds 30000, audio time length control data is made to be short, for example, to be {Dur=5 [sec]}; and accordingly, the audio article data which is liable to receive botheration due to too loud voice can be listened at fast speed or skipped.

Also in the case where the article data is text article data, a keyword may be detected as in the before mention. Alternatively, semantic extraction or the like by a text-mining tool is performed, and the auxiliary data corresponding to semantics may be allocated.

According to the present example, the auxiliary data can be automatically generated from data stored in the multimedia database 101; and therefore, it becomes possible to generate contents automatically having an appropriate presentation order, audio feature, acoustic effect, time length, and the like.

Furthermore, the above mentioned third example may be combined with the present example. For example, it is possible to provide a configuration in which, as for the audio article data, as described in the third example, a user inputs the auxiliary data in the auxiliary data input unit 106; and as for the text article data, as described in the present example, the auxiliary data is generated in the auxiliary data generation unit 107.

In doing so, there can be established a system in which, in order to simplify work, the auxiliary data is manually inputted by the user only when it is necessary, and the auxiliary data is automatically generated under normal conditions.

### Example 5

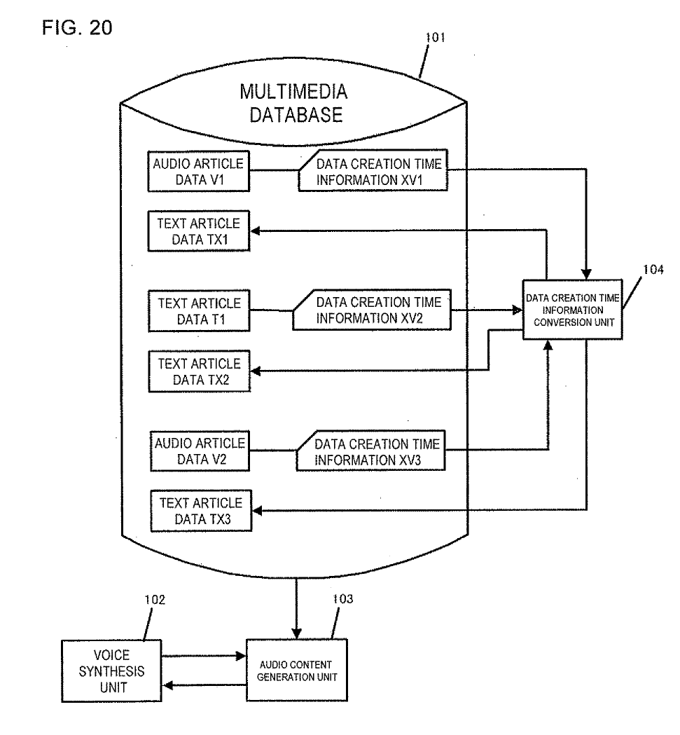

Subsequently, a fifth example of the present invention corresponding to the above mentioned third exemplary embodiment will be described. Hereinafter, description will be made in detail with reference to FIG. 20 showing an outline of the present example.

In the present example, a multimedia database 101, a voice synthesis unit 102, and an audio content generation unit 103 have the same functions as reference numerals 101 to 103 shown in the above mentioned second example.

Data creation time information corresponding to each article data is stored in the multimedia database 101. The data creation time information is data (attribute information) at the time when audio article data or text article data is created, and includes at least one of situation in which data is created (date and time, circumstances, the number of past data creations, and the like), information of a creator (name, gender, age, address, and the like), and the like. As for a description format of the data creation time information, every format of text is conceivable, and any format may be adopted.

In a data creation time information conversion unit 104, data creation time information is read out from the multimedia database 101, is converted into text, and is registered as new text article data in the multimedia database 101.

For example, as data creation time information XVI corresponding to audio article data V1, it is regarded as that there is stored as {Name=TARO, Address=TOKYO, Age=21}.

The data creation time information conversion unit 104 converts XV1 into text article dataTX1 of “TAROwho is resident in TOKYO and aged 21 years created this data.”

Then, the text article data TX1 is stored in the multimedia database 101 as in other text article data.

After that, the generated text article data TX1 is voiced by the audio content generation unit 103 and the voice synthesis unit 102, and is used for generating audio contents.

In doing as the present example does, the data creation time information is converted into comprehensible text and voiced; and therefore, it becomes possible that a listener of the audio contents easily understand as to what-like information at the time of creation is included in each data in the contents.

Furthermore, in the above mentioned example, the description is made that it is regarded as that the text article data generated by the data creation time information conversion unit 104 is once stored in the multimedia database 101 as the text article data; however, it is also possible that the data creation time information conversion unit 104 generates synthetic tone by directly controlling the voice synthesis unit 102, and stores as the audio article data in the multimedia database 101.

Further, it is also possible that the above voiced audio article data is not stored in the multimedia database 101, but is directly sent to the audio content generation unit 103 to generate audio contents. In this case, it is preferable that the audio content generation unit 103 gives a timing at which the data creation time information conversion unit 104 performs conversion.

### Example 6

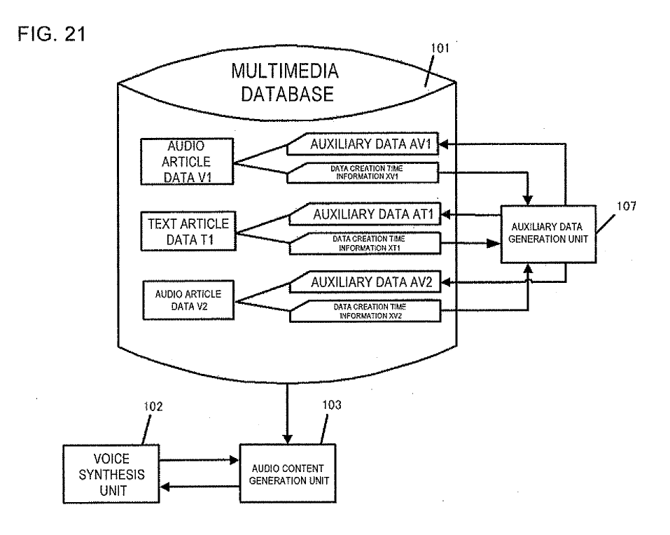

Subsequently, a sixth example of the present invention corresponding to the above mentioned sixth exemplary embodiment will be described. Hereinafter, description will be made in detail with reference to FIG. 21 showing an outline of the present example.

In the present example, in addition to the first example, an auxiliary data generation unit 107 creates auxiliary data from data creation time information stored in a multimedia database 101.

The data creation time information is the same as the data creation time information described in the above mentioned example 5. The auxiliary data is equal to any one or more of presentation order data, audio feature parameters, acoustic effect parameters, and audio time length control data.

As an example, it is regarded as that audio article data V1 and V2 and text article data T1 are stored in the multimedia database 101. Data creation time information XV1, XV2 and XT1 are correspondingly stored in the article data V1, V2, and T1, respectively.

The data creation time information XV1, XV2, and XT1 may be attached to each of the article data V1, V2, and T1 as metadata, or may be stored by using a different database entry or a different file.

The auxiliary data generation unit 107 creates the auxiliary data on the basis of name, gender, created date and time, and the like described in the data creation time information. For example, it is regarded as that the contents are such that the data creation time information XV1 is {Name=TARO, Time=Feb. 8, 2006}, XV2 is {Gender=male, Time=Feb. 10, 2006}, and XT1 is {Name=HANAKO, Gender=female, Age=18}; and the present is Feb. 10, 2006.

In the auxiliary data generation unit 107, internal information of “background music for TARO, and audio time length control data for data created before the previous day” is generated for the article data V1; entity of the preliminarily given “background music for TARO,” and “audio time length control data for data created before the previous day” is allocated; and auxiliary data AV1 corresponding to the article data V1 is created.

Furthermore, similarly, there are created auxiliary data AV2 by “acoustic effect for men, and audio time length control data for data created on the day” for the article data V2; and auxiliary data AT1 by “audio feature parameters for women, and acoustic effect for 10s” for the article data T2. Similarly, entity of the “audio feature parameters for women” or the like is also preliminarily given.

According to the present example, it becomes possible, for example, data created on the day is made to be read in a usual speed and the more created date and time is earlier, the more audio time length is made to be shorter; and accordingly, made to be read lightly.

Besides, in the case where a writer of the text article data is registered, synthetic tone having a feature that resembled the writer can be generated.

Furthermore, the present example may be combined with the aforementioned third and fourth examples. For example, in the case where detail data creation time information is present in only the audio article data V2, it is possible that, as for the audio article data V1, as described in the third example, a user inputs the auxiliary data AV1 in the auxiliary data input unit 106; as for the text article data T1, as described in the fourth example, the auxiliary data AT1 is generated in the auxiliary data generation unit 107; and as for the audio article data V2, as described in the present example, the auxiliary data AV2 is created in the auxiliary data generation unit 107 in accordance with the data creation time information.

In doing so, there can be established a system which changes a creation method of the auxiliary data depending on a degree of enhancement of the data creation time information.

### Example 7

Subsequently, a seventh example of the present invention that is one modified exemplary embodiment of the above mentioned second exemplary embodiment will be described. The present example can be actualized by the same configuration as the second example of the present invention; and therefore, the operation will be described with reference to the previous FIG. 13.

When article data is read out from a multimedia database 101, an audio content generation unit 103 generates acoustic effect parameters which is determined by two article data which are adjacent in temporal sequence on audio contents to be outputted, and applies them as acoustic effect between the relevant article data.

One of the standards of the acoustic effect parameters to be generated in this case is four types of combinations depending on as to whether the type of adjacent two article data is audio article data or text article data.

For example, in the case where the precedent data and the subsequent data are the audio article data, music with high audio quality may be used as jingle; and accordingly, atmosphere can be harmonized. Besides, in the case where the precedent data is the audio article data and the subsequent data is the text article data, a musical pitch lowering chime may be used for acoustic effect; and accordingly, implication can be given to a listener that naturalness is lowered next. Furthermore, in the case where the precedent data is the text article data and the subsequent data is the audio article data, a musical pitch rising chime may be used for the acoustic effect; and accordingly, expectation can be given to the listener that the naturalness is raised next. In addition, in the case both the precedent data and the subsequent data are the text article data, calm music may be used as the jingle; and accordingly, mood-stabilizing effect can be given.

Besides, in a different one standard of the acoustic effect parameters, when the adjacent article data are both the text article data, each of the data is performed by morphological analysis and frequency of appearance of words is calculated; and its Euclidean distance is defined as a distance between the text article data. Then, a chime having a length proportionate to the same distance is used for the acoustic effect; and accordingly, a case where the relation between the article data is deep can be easily made out from a case where the relation is shallow.

Furthermore, in a different one standard of the acoustic effect parameters, when the adjacent article data are both the audio article data, if audio qualities of the audio feature parameters corresponding to the respective audio article data are equivalent, music is streamed astride two articles; and accordingly, linkage between the article data can be smoothed.

In addition, in a different one standard of the acoustic effect parameters, when the adjacent article data are both the audio article data, an absolute value of difference between values of average pitch frequencies of the audio feature parameters corresponding to the respective audio article data is calculated; and accordingly, a feeling of discomfort caused by difference in pitch between the article data can be reduced by using presence of a length proportionate to the value.

Further, in a different one standard of the acoustic effect parameters, when the adjacent article data are both the audio article data, an absolute value of difference between values of speech speeds of the audio feature parameters corresponding to the respective audio article data is calculated and music having a length proportionate to the value is inserted; and accordingly, a feeling of discomfort caused by difference in speech speed between the article data is reduced.

In the present example, the description is made that it is regarded as that the audio content generation unit 103 generates the acoustic effect parameters; however, it is possible to actualize even by a configuration in which the acoustic effect parameters is once stored in the multimedia database 101, and the audio content generation unit 103 reads out the same acoustic effect parameters again and controls.

Alternatively, the audio content generation unit 103 may directly apply the corresponding acoustic effect without generating the acoustic effect parameters.

### Example 8

Subsequently, an eighth example of the present invention that is one modified exemplary embodiment of the above mentioned second exemplary embodiment will be described. The present example can be actualized by the same configuration as the second example of the present invention; and therefore, the operation thereof will be described with reference to the previous FIG. 13.

When some article data is added in the process in which audio contents are sequentially generated, in the case where the entire time length exceeds preliminarily given the entire time of the audio contents, an audio content generation unit 103 operates so as not to add relevant article data.

This can limit the upper limit of the entire time length; and consequently, the audio contents can be dealt easily as a program.

Alternatively, in the case where the entire time length of the audio contents created by entirely using all the article data to be used exceeds the preliminarily given entire time of the audio contents, it is possible that the audio content generation unit 103 once generates the audio contents as to all combinations in which the respective article data are used or not used, and operates so that the time length does not exceed the preliminarily given entire time of the audio contents and selects the closest combination.

Furthermore, in place of the entire time of the preliminarily given audio contents, it may be such that the upper limit, the lower limit, or both limits of the entire time of the aforementioned audio contents are set and controlled so as to conform thereto.

### Example 9

Subsequently, a ninth example of the present invention corresponding to the above mentioned seventh exemplary embodiment will be described. Hereinafter, description will be made in detail with reference to FIG. 10 showing an outline of the present example.

An audio content generation unit 103 once sends auxiliary data corresponding to respective article data which perform sequential processing to an auxiliary data correction unit 108.

The auxiliary data correction unit 108 refers to auxiliary data used before the relevant time, corrects the relevant auxiliary data, and sends to the audio content generation unit 103.

The audio content generation unit 103 generates audio contents by using the corrected auxiliary data.

As for a method for correcting the auxiliary data in the auxiliary data correction unit 108, for example, in the case where the auxiliary data is acoustic effect parameters, types of BGM of the acoustic effect parameters used in the past time are preliminarily classified and tags are assigned thereto.

In this case, as a music tag, there is considered a case that four types of classic, jazz, rock, and J-POP can be assigned.

For example, in the case where all the BGM used in the past are classic, if the BGM of the relevant acoustic effect parameters under processing is assigned with a tag other than classic, the BGM assigned with a tag other than classic is mandatorily corrected to any music assigned with a classic tag.

With this, in the audio contents to be generated, all the BGM is unified by classic; and consequently, it becomes possible to unify the entire atmosphere in the case where the entire audio contents are treated as a program.

### Example 10

Subsequently, a tenth example of the present invention corresponding to the above mentioned eighth exemplary embodiment will be described. Hereinafter, description will be made in detail with reference to FIG. 11 showing an outline of the present example.

A multimedia content generation unit 201 reads out article data from a multimedia database 101 and generates multimedia contents.

The multimedia contents generated in this case are a web page, a blog page, an electronic bulletin board page, and the like which include character information, audio information, and the like.

For example, in the case of the web page, the audio information is not supplied with an HTML file which is the same as the character information; but, it may be one in which a link for accessing is supplied.

A multimedia content user interactive unit 202 supplies the multimedia contents in accordance with the operation of a website audience of the multimedia contents.

In the case where the multimedia contents are web pages mainly made up of HTML files, a general purpose Web browser on the user terminal side may be used as the multimedia content user interactive unit 202.

Information in which the website audience clicks the link set in the multimedia contents is recognized by the multimedia content user interactive unit 202, and is sent to the multimedia content generation unit 201.

The multimedia content generation unit 201 generates the multimedia contents depending on the operation of the aforementioned website audience, and sends to the multimedia content user interactive unit 202; and accordingly, the multimedia contents are presented to the website audience.

The multimedia content user interactive unit 202 creates text data registered in the multimedia database 101 and a message list which is for browsing or listening audio data. The aforementioned message list is a part of list or all of lists of the text data and the audio data registered in the multimedia database 101, and a user can select contents in which the user wants to browse or listen from these lists.

Furthermore, the multimedia content generation unit 201 records browse history of each article obtained on this occasion for every website audience in the multimedia database 101. As for the browse history, there may be included a browse order that which article is browsed next to what article, its statistical transition information, or the number of browses/the number of reproductions of every article so far.

In the present example, An audio content generation unit 103 selects articles and generates audio contents in accordance with the rules preliminarily set by a user having administrator authority.

The rules are not particularly limited; however, for example, there may be adopted a method in which the aforementioned browse record is read out, and articles are selected beginning at the top of the number of browses or the number of reproductions in a range not exceeding a preliminarily determined number of articles or a preliminarily determined time.

Furthermore, similarly, there may be also adopted a method in which, in the range not exceeding the preliminarily determined number of articles or the preliminarily determined time, the aforementioned browse history is read out, and articles in which the number of browses or the number of reproductions is equal to or more than a predetermined value are selected in a registration time order to the multimedia database 101.

In addition, there may be adopted a method in which the aforementioned browse history is read out, and the audio contents are generated in an order in which a website audience of the nearest multimedia contents browses (reproduces) articles. Further, there may be also adopted a method in which, in a system capable of identifying the website audience of the multimedia contents by performing login or the like, the audio contents are generated in an order in which articles are browsed by the website audience specified by a user. By adopting each of the above mentioned methods, it is possible to obtain the audio contents which reflect browse preference of the website audience (example: PC user) of the multimedia contents with high degree of freedom of browse. For example, it becomes possible that articles browsed by acquaintances who share common tastes and interests are listened at fast speed by audio, and user's browse history of multimedia contents specified for celebrity or the like is relived by only audio; and it becomes possible to provide a new form of audio blogs and radio programs.

It becomes possible to provide circumstances in which contents are effectively browsed for a listener of audio contents restrained by a reproduction order (example: user of portable audio player) by performing selection and rearrangement of the above mentioned articles. Of course, an arrangement order of the article in the audio contents is not limited to the above mentioned example; but, it is possible to provide various variations in accordance with article property and users' needs.

### Example 11

Subsequently, a service capable of providing by using an audio content generation system according to the present invention will be described in detail as an eleventh example of the present invention. Hereinafter, in the present example, there will be described an information exchange service in which, with respect to contents (initial contents) created by one content creator, contents are added and updated by a plurality of comment posters and the aforementioned content creator.

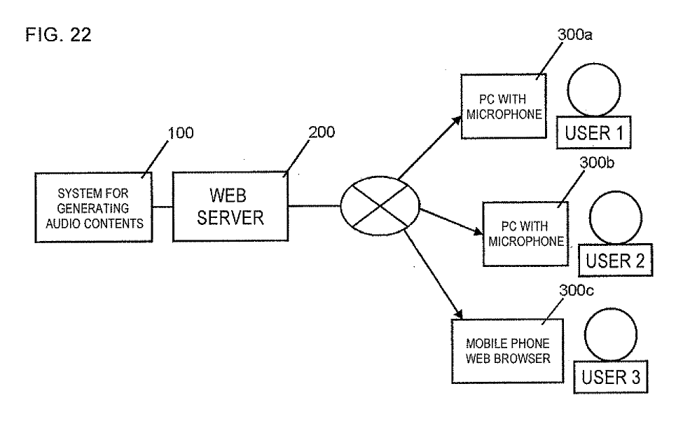

As shown in FIG. 22, there exist circumstances in which a large number of users (in this case, users 1 to 3) via the Internet can connect to a Web server 200 via user terminals 300a to 300c.

The Web server 200 constitutes a multimedia content generation unit 201 and a multimedia content user interactive unit 202 described in the above mentioned eighth exemplary embodiment. The Web server 200 is connected to an audio content generation system 100 which includes the multimedia database 101, the voice synthesis unit 102, the audio content generation unit 103 described in the above mentioned respective exemplary embodiments, and is capable of providing audio contents in which synthesized voice and audio data are organized in accordance with a predetermined order at the request of a user.

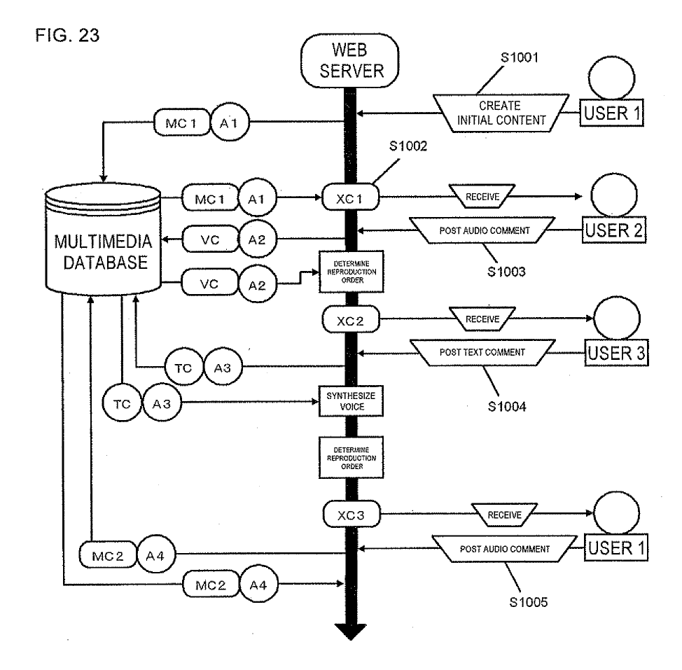

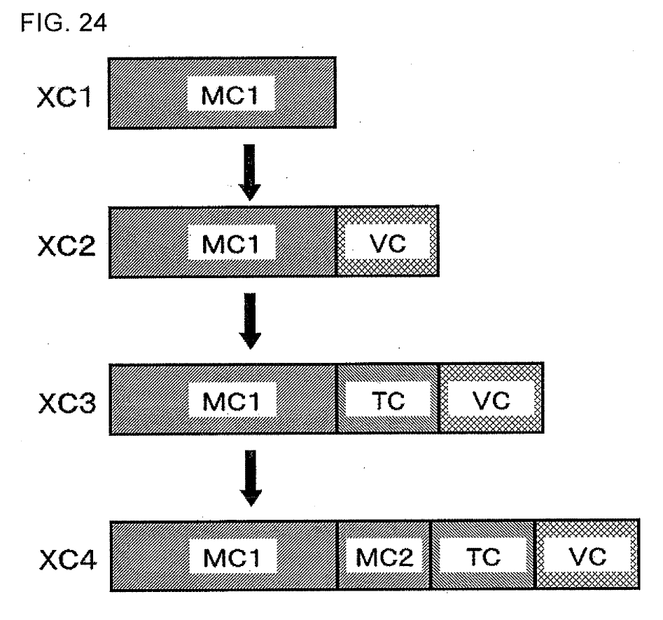

Subsequently, referring to FIGS. 23 and 24, there will be described a process in which contents are updated in each posting by the users 1 to 3. First, the user 1 records audio comments of the user 1 and creates initial contents MC1 by a recording apparatus such as a microphone or the like of a user terminal 300a (PC with microphone). (Step S1001 shown in FIG. 23).

Furthermore, in this case, it is regarded as that only the user 1 has posting authority of the initial contents and decision authority of organization rules of the audio contents as an establisher. Hereinafter, it is regarded as that the organization rules, in which comments of the user 1 (establisher) are arranged at the head of the audio contents so as to be continued (establisher priority); and as for remaining users' postings, the more frequency of former posting, the faster reproduction order of the comments (posting frequency priority), are determined.

Next, the user 1 uploads the initial contents MC1 in the Web server 200. The uploaded initial contents MC1 is stored in the multimedia database 101 together with auxiliary data A1. The audio content generation system 100 organizes contents XC1 by using the initial contents MC1 and the auxiliary data A1 (see XC1 shown in FIG. 24).

The generated audio contents XC1 is delivered on the Internet via the Web server 200 (step S1002 shown in FIG. 23).

The user 2 who is in contact with the contents of the received audio contents XC1 records corresponding impression and comments, backup messages, and the like; creates audio comments VC; gives auxiliary data A2 such as posting date and time, a poster name, and the like; and uploads in the Web server 200 (step S1003 shown in FIG. 23).

The uploaded audio comments VC are stored in the multimedia database 101 together with the auxiliary data A2. The audio content generation system 100 determines a reproduction order on the basis of the auxiliary data A1 and A2 and the like given to the initial contents MC1 and the audio comments VC. In this case, only one comment is given to one content; and therefore, as noted in the aforementioned organization rules of the audio contents, a reproduction order that is the initial contents MC1→the audio comments VC is determined, and audio contents XC2 are generated (see XC2 shown in FIG. 24).

The generated audio contents XC2 are delivered on the Internet via the Web server 200 as in the above mentioned audio contents XC1.

The user 3 who is in contact with the contents of the received audio contents XC2 performs text input of corresponding impression and comments, backup messages, and the like from a data operation unit of a user terminal 300c for the user 3; creates text comments TC; gives auxiliary data A3 such as posting date and time, a poster name, and the like; and uploads in the Web server 200 (step S1004 shown in FIG. 23).

The uploaded text comments TC are stored in the multimedia database 101 together with the auxiliary data A3. The audio content generation system 100 determines a reproduction order on the basis of the auxiliary data A1 to A3 given to the initial contents MC1, the audio comments VC, and the text comments TC. In this case, if it is assumed that the user 3 posted more comments than the user 2 in the past, a reproduction order that is the initial contents MC1→the text comments TC→the audio comments VC is determined by the aforementioned organization rules of the audio contents (posting frequency priority); and audio contents XC3 are generated after making synthesized voice of the text comments TC (see XC3 shown in FIG. 24).

The user 1 who is in contact with the contents of the received audio contents XC3 creates additional contents MC2 from the data operation unit of the user terminal 300a for the user 1; gives auxiliary data A4; and uploads in the Web server 200 (step S1005 shown in FIG. 23).

The uploaded additional contents MC2 are stored in the multimedia database 101 together with the auxiliary data A4. The audio content generation system 100 determines a reproduction order on the basis of the auxiliary data A1 to A4 given to the initial contents MC1, the audio comments VC, the text comments TC, and the additional contents MC2.

In this case, a reproduction order that is the initial contents MC1→the additional contents MC2→the text comments TC→the audio comments VC is determined by the aforementioned organization rules of the audio contents (establisher priority), and audio contents XC4 are generated (see XC4 shown in FIG. 24).

As described above, updating and delivery of the audio contents including the comments given from other users are repeated with the contents MC1 and MC2 of the user 1 (establisher) as axes.

In addition, the description is made by using the example in which the audio contents are uploaded as the initial contents in the above mentioned examples; however, as a matter of course, it is possible that text contents created by using a character input interface of a PC and a mobile phone are set as initial contents. In this case, the text contents are transmitted to the audio content generation system 100 side; and, by a voice synthesis unit thereof, delivered as the audio contents after performing speech synthesis process.

Besides, in the above mentioned example, the description is made that the Web server 200 performs an interactive process mainly with users, and the audio content generation system 100 disperses load so as to perform the speech synthesis process and order change process; however, it is possible to put together these processes, or to make other workstation or the like assume a part of the processes.

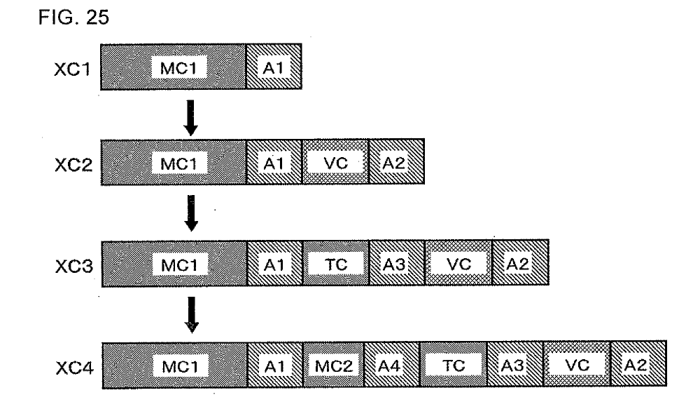

Furthermore, in the above mentioned example, the description is made that the auxiliary data A1 to A4 are used for determining the reproduction order; however, for example, as shown in FIG. 25, it is also possible to voice data creation time information in the auxiliary data, and to generate the audio contents XC1 to XC4 provided with annotation about the respective contents and registration date and time of the comments.

Further, in the above mentioned example, the description is made that the text comments TC are stored in the multimedia database 101 still in a text format; however, it is also effective to store in the multimedia database 101 after performing the speech synthesis process and producing synthetic tones.

### INDUSTRIAL APPLICABILITY

As described above, according to the present invention, text of an information source including mixed text and audio is voiced; and audio contents capable of being listened by only audio may be generated. This feature may establish an audio-text mixed blog system which is preferably applied to an information exchanging system, for example, a blog or a bulletin board, in which a plurality of users can input contents in audio or text by using a personal computer and a mobile phone; permits posting in both text and audio; and allows to browse (listen) all articles by only audio.

As described above, exemplary embodiments and their specific examples which are for implementing the present invention are described; however, it is to be understood that various modifications may be made without departing from the spirit or scope of the present invention that an information source including mixed audio data and text data serves as an input, synthesized voice is generated for the text data by using the voice synthesis unit, and audio contents in which the synthesized voice and the audio data are organized in accordance with a predetermined order are generated. For example, in the above mentioned exemplary embodiments, the description is made by using examples which apply the present invention to a blog system; however, it is to be understood that the present invention can be applied to a system which performs audio services from an information source including mixed other audio data and text data.

This application is based upon and claims the benefit of priority from the Japanese patent application No. 2006-181319, filed on Jun. 30, 2006, the disclosure of which is incorporated herein in its entirety by reference.

1. An audio content generation system including a voice synthesis unit which generates synthesized voice from text, said audio content generation system comprising:
an audio content generation unit which generates synthesized voice for said text data by using said voice synthesis unit from an information source including mixed audio data and text data serves as an input, and generates audio contents in which said synthesized voice and said audio data are organized in accordance with a predetermined order.

2. An audio content generation system which including a voice synthesis unit which generates synthesized voice from text, said audio content generation system comprising:
an audio content generation unit which is connected to a multimedia database in which contents mainly composed of audio data or text data are registered respectively, generates synthesized voice for said text data registered in said multimedia database by using said voice synthesis unit, and generates audio contents in which said synthesized voice and said audio data are organized in accordance with a predetermined order.

3. The audio content generation system as set forth in claim 2,
wherein said multimedia database has content attribute information which includes at least one of created date and time, circumstances, the number of past data creations, creator's name, gender, age, and address registered in association with contents mainly composed of said audio data or said text data,
further comprising a content attribute information conversion unit which makes said voice synthesis unit generate synthesized voice corresponding to the contents of said content attribute information, and
wherein said audio content generation unit generates audio contents in which attributes of said respective contents are confirmable by said synthesized voice generated by said content attribute information conversion unit.

4. The audio content generation system as set forth in claim 2 or 3,
wherein said audio content generation unit generates audio contents which read aloud the synthesized voice generated from said text data and said audio data in accordance with presentation order data preliminarily registered in said multimedia database.

5. The audio content generation system as set forth in claim 4,
further comprising a data input unit which registers contents mainly composed of audio data or text data and said presentation order data in said multimedia database.

6. The audio content generation system as set forth in claim 4 or 5,
further comprising a presentation order data generation unit which generates said presentation order data on the basis of said audio data or said text data, and
wherein said audio content generation unit generates audio contents which reads aloud the synthesized voice generated from said text data and said audio data in accordance with said presentation order data.

7. The audio content generation system as set forth in claim 4 or 5,
further comprising a presentation order data generation unit which generates said presentation order data on the basis of said content attribute information, and
wherein said audio content generation unit generates audio contents which reads aloud the synthesized voice generated from said text data and said audio data in accordance with said presentation order data.

8. The audio content generation system as set forth in any one of claims 4 to 7,
further comprising a presentation order data correction unit which automatically corrects said presentation order data in accordance with predetermined rules.

9. The audio content generation system as set forth in any one of claims 2 to 8,
wherein said multimedia database has audio feature parameters registered therein, said audio feature defining an audio feature when said text data is converted into audio, and
said audio content generation unit reads out said audio feature parameters, and makes said voice synthesis unit generate synthesized voice by an audio feature using said audio feature parameters.

10. The audio content generation system as set forth in claim 9,
further comprising a data input unit which registers contents mainly composed of audio data or text data and said audio feature parameters in said multimedia database.

11. The audio content generation system as set forth in claim 9 or 10,
further comprising an audio feature parameter generation unit which generates said audio feature parameters on the basis of said audio data or said text data, and
wherein said audio content generation unit makes said voice synthesis unit generate the synthesized voice by an audio feature using said audio feature parameters.

12. The audio content generation system as set forth in any one of claims 3, 9, or 10,
further comprising an audio feature parameter generation unit which generates said audio feature parameters on the basis of said content attribute information, and
wherein said audio content generation unit makes said voice synthesis unit generate the synthesized voice by an audio feature using said audio feature parameters.

13. The audio content generation system as set forth in any one of claims 9 to 12,
further comprising an audio feature parameter correction unit which automatically corrects audio feature parameters in accordance with predetermined rules.

14. The audio content generation system as set forth in any one of claims 2 to 13,
wherein said multimedia database has acoustic effect parameters registered therein, said acoustic effect parameters being given to the synthesized voice generated from said text data, and
said audio content generation unit reads out said acoustic effect parameters and gives acoustic effect using said acoustic effect parameters to the synthesized voice generated by said voice synthesis unit.

15. The audio content generation system as set forth in claim 14,
further comprising a data input unit which registers contents mainly composed of audio data or text data and said acoustic effect parameters in said multimedia database.

16. The audio content generation system as set forth in claim 14 or 15,
wherein said audio content generation unit generates acoustic effect parameters which indicate at least one of a continuous state of the synthesized voice converted from said text data, and said audio data, a difference between the appearance frequency of predetermined words, a difference between the audio quality of the audio data, a difference between the average pitch frequency of the audio data, and a difference between the speech speed of the audio data; and gives acoustic effect using said acoustic effect parameters so as to extend between said synthesized voices, between said audio data, or between said synthesized voice and said audio data.

17. The audio content generation system as set forth in claim 14 or 15,
further comprising an acoustic effect parameter generation unit which generates said acoustic effect parameters on the basis of said audio data or said text data, and
wherein said audio content generation unit gives acoustic effect using said acoustic effect parameters to the synthesized voice generated by said voice synthesis unit.

18. The audio content generation system as set forth in any one of claims 3, 14, or 15,
further comprising an acoustic effect parameter generation unit which generates said acoustic effect parameters on the basis of said content attribute information, and
wherein said audio content generation unit gives acoustic effect using said acoustic effect parameters to the synthesized voice generated by said voice synthesis unit.

19. The audio content generation system as set forth in claim 17 or 18,
wherein said acoustic effect parameter generation unit generates acoustic effect parameters which indicate at least one of a continuous state of the synthesized voice converted from said text data and said audio data, a difference between the appearance frequency of predetermined words, a difference between the audio quality of the audio data, a difference between the average pitch frequency of the audio data, and a difference between the speech speed of the audio data; and are given in a state extending between said synthesized voices, between said audio data, or between said synthesized voice and said audio data.

20. The audio content generation system as set forth in any one of claims 14 to 19,
further comprising an acoustic effect parameter correction unit which automatically corrects said acoustic effect parameters in accordance with predetermined rules.

21. The audio content generation system as set forth in any one of claims 2 to 20,
wherein said multimedia database has audio time length control data registered therein, said audio time length control data defining time length of the synthesized voice generated from said text data, and
said audio content generation unit reads out said audio time length control data and makes said voice synthesis unit generate synthesized voice having audio time length corresponding to said audio time length control data.

22. The audio content generation system as set forth in claim 21,
further comprising a data input unit which registers contents mainly composed of audio data or text data and said audio time length control data in said multimedia database.

23. The audio content generation system as set forth in claim 21 or 22,
further comprising an audio time length control data generation unit which generates said audio time length control data on the basis of said audio data or said text data, and
wherein said audio content generation unit makes said voice synthesis unit generate synthesized voice having audio time length corresponding to said audio time length control data.

24. The audio content generation system as set forth in any one of claims 3, 21, or 22,
further comprising an audio time length control data generation unit which generates said audio time length control data on the basis of said content attribute information, and
wherein said audio content generation unit makes said voice synthesis unit generate synthesized voice having audio time length corresponding to said audio time length control data.

25. The audio content generation system as set forth in any one of claims 21 to 24,
further comprising an audio time length control data correction unit which automatically corrects said audio time length control data in accordance with predetermined rules.

26. The audio content generation system as set forth in any one of claims 1 to 25,
wherein said audio content generation unit edits said text data and said audio data so that audio contents are fallen within a predetermined time length.

27. An information exchanging system which includes the audio content generation system as set forth in any one of claims 2 to 26, and is used for information exchange between a plurality of user terminals, said information exchanging system comprising:
a unit which accepts registration of text data or audio data from one user terminal to said multimedia database; and
a unit which transmits the audio contents generated by said audio content generation unit to user terminals which require service by audio,
wherein information exchange between said respective user terminals is actualized by repeating reproduction of said transmitted audio contents and additional registration of contents by said audio data or a text format.

28. The information exchanging system as set forth in claim 27, further comprising:
a unit which generates a message list for browsing and listening the text data or the audio data registered in said multimedia database, and presents to said user terminals to be accessed; and
a unit which counts the number of browses and the number of reproductions of said respective data based on said message list, respectively,
wherein said audio content generation unit generates audio contents which reproduce text data and audio data in which said number of browses and said number of reproductions are equal to or more than a predetermined value.

29. The information exchanging system as set forth in claim 27, further comprising:
a unit which generates a message list which is for browsing and listening the text data or the audio data registered in said multimedia database, and presents to user terminals to be accessed; and
a unit which records browse history of each of said data based on said message list for each user,
wherein said audio content generation unit generates audio contents which reproduce text data and audio data in accordance with an order pursuant to browse history of an arbitrary user designated from said user terminals.

30. The information exchanging system as set forth in any one of claims 27 to 29,
wherein said data to be registered in said multimedia database are weblog article contents composed of text data or audio data, and
said audio content generation unit arranges said weblog article contents of a weblog establisher at the top in a registration order, and generates audio contents in which comments registered from other user are arranged in accordance with said predetermined rules.

31. A program which is executed by a computer, which is connected to a multimedia database in which contents mainly composed of audio data or text data are registered respectively, said program making said computer function as the following units of:
a voice synthesis unit which generates synthesized voice corresponding to said text data registered in said multimedia database; and
an audio content generation unit which generates audio contents in which said synthesized voice and said audio data are organized in accordance with a predetermined order.

32. An audio content generating method which uses an audio content generation system connected to a multimedia database which has contents mainly composed of audio data or text data respectively registered therein, and has content attribute information including at least one of created date and time, circumstances, the number of past data creations, creator's name, gender, age, and address registered in association with said respective contents, said audio content generating method comprising:
generating synthesized voice corresponding to said text data registered in said multimedia database by said audio content generation system,
generating synthesized voice corresponding to said content attribute information registered in said multimedia database by said audio content generation system, and
organizing said synthesized voice corresponding to said text data, said audio data, and said synthesized voice corresponding to said content attribute information in accordance with a predetermined order, and generating audio contents which are audible by only audio by said audio content generation system.

33. An information exchanging method which uses an audio content generation system connected to a multimedia database in which contents mainly composed of audio data or text data are registered respectively; and a user terminal group connected to said audio content generation system, said information exchanging method comprising:
registering contents mainly composed of audio data or text data in said multimedia database by one user terminal;
generating corresponding synthesized voice for the text data registered in said multimedia database by said audio content generation system;
generating audio contents in which said synthesized voice corresponding to said text data and said audio data registered in said multimedia database are organized in accordance with a predetermined order by said audio content generation system; and
transmitting said audio contents in response to the request of the other user terminal by said audio content generation system,
wherein information exchange between said user terminals is actualized by repeating reproduction of said audio contents and additional registration of contents by said audio data or a text format.
